(19) United States
(12) Patent Application Publication
(10) Pub. No.: US 2025/0006897 A1
(43) Pub. Date: Jan. 2, 2025

(54) LITHIUM METAL ANODE ASSEMBLIES AND AN APPARATUS AND METHOD OF MAKING

(71) Applicant: LI-METAL CORP., Markham (CA)

(72) Inventors: Timothy George JOHNSTON, Toronto (CA); Maciej JASTRZEBSKI, Toronto (CA)

(73) Assignee: LI-METAL CORP., Markham, ON (CA)

(21) Appl. No.: 18/249,130

(22) PCT Filed: Oct. 16, 2021
(86) PCT No.: PCT/CA2021/051454

§ 371 Date: Apr. 14, 2023

Related U.S. Application Data
(60) Provisional application No. 63/092,849, filed on Oct. 16, 2020.
(60) Provisional application No. 63/190,738, filed on May 19, 2021.
(60) Provisional application No. 63/222,857, filed on Jul. 16, 2021.

(51) Int. Cl. H01M 4/36; H01M 4/02; H01M 4/134; H01M 4/38; H01M 4/62; H01M 4/66; H01M 4/74

(52) U.S. Cl. CPC H01M 4/366; H01M 4/134; H01M 4/382; H01M 4/628; H01M 4/662; H01M 4/74; H01M 2004/027

(57) ABSTRACT

A multi-layer, lithium anode assembly for use in a lithium-based battery can include a substrate region having a current collector comprising a continuous copper foil that is between 4 and 10 microns thick and has a lithium compatible support surface. A lithium hosting region may overlie the support surface and may include a lithium material film deposited directly onto the support surface via thermal evaporation and having a thickness that is between 1 microns and 10 microns. A cover region may be located outboard of the lithium hosting region and may have a cover film that is formed from a passivation material and covers the lithium material film. The cover region may allow a lithium ion flux between an electrolyte and the lithium hosting region and inhibiting irreversible reactions between the lithium hosting region and the electrolyte or surrounding environment.

### CROSS REFERENCE TO RELATED APPLICATIONS

This application claims the benefit of and priority to U.S. provisional application No. 63/092,849 filed Oct. 16, 2020, and U.S. provisional application No. 63/190,738 filed May 19, 2021, and U.S. provisional application No. 63/222,857 filed Jul. 16, 2021. The entirety of these applications being incorporated herein by reference.

### FIELD OF THE INVENTION

In one of its aspects, the present disclosure relates to the production and use of multi-later anode assemblies that are suitable for use with batteries including, for example, lithium ion and lithium metal solid state batteries, but that do not utilize a lithium foil, and methods and apparatuses for producing the same.

### INTRODUCTION

Japanese patent publication no. JP2797390B2 discloses a negative electrode and a carbonaceous material and a current collector as an anode active material, a positive electrode having a lithium compound as a positive electrode active material, a secondary battery and a nonaqueous electrolyte, the positive electrode active material, the second having a main active material composed of a first lithium compound having a nobler potential than the oxidation potential of the current collector, a lower potential than the oxidation potential of the collector. By including a subsidiary active substance consisting of lithium compound, it is obtained so as to have excellent properties against over-discharge.

U.S. Pat. No. 10,177,366 discloses a high purity lithium and associated products. In a general embodiment, the present disclosure provides a lithium metal product in which the lithium metal is obtained using a selective lithium ion conducting layer. The selective lithium ion conducting layer includes an active metal ion conducting glass or glass ceramic that conducts only lithium ions. The present lithium metal products produced using a selective lithium ion conducting layer advantageously provide for improved lithium purity when compared to commercial lithium metal. Pursuant to the present disclosure, lithium metal having a purity of at least 99.96 weight percent on a metals basis can be obtained.

U.S. Pat. No. 7,390,591 discloses ionically conductive membranes for protection of active metal anodes and methods for their fabrication. The membranes may be incorporated in active metal negative electrode (anode) structures and battery cells. In accordance with the invention, the membrane has the desired properties of high overall ionic conductivity and chemical stability towards the anode, the cathode and ambient conditions encountered in battery manufacturing. The membrane is capable of protecting an active metal anode from deleterious reaction with other battery components or ambient conditions while providing a high level of ionic conductivity to facilitate manufacture and/or enhance performance of a battery cell in which the membrane is incorporated.

U.S. patent publication no. 2020/0194786 discloses a system for electrical energy production from chemical reagents in a compartmentalized cell includes: at least two electrodes, comprising at least one anode and at least one cathode; at least one separator, that separates the anodes and the cathodes; and an ionic liquid electrolyte system. The system can be a battery or one or more cells of a battery system. The ionic liquid electrolyte system comprises an ionic liquid solvent; an ether co-solvent, comprising a minority fraction, by weight, of the electrolyte; and a lithium salt. In preferred variations, the anode is a lithium metal anode and the cathode is a metal oxide cathode and the separator is a polyolefin separator.

### SUMMARY

Attempts have been previously made to provide lithium anodes suitable for liquid electrolyte metal lithium ion (LMB), hybrid lithium metal (HLB) and solid-state batteries (SSB). These anode have typically been made by foil rolling and extrusion processes. The difficulties in rolling lithium, which is reactive, physically weak, and suffers from self-adhesion, are well known and can limit the practical thickness at which such foils can be rolled and handled to greater than 20 microns.

One way of eliminating some of the difficulties of handling lithium anodes is to form the anode in place on a stronger substrate. This allows loads to pass through a stronger material which, in some cases, can also function as the anode current collector.

For example, U.S. Pat. No. 10,177,366 teaches a lithium anode deposited on a substrate, made by electrolysis from an aqueous solution of lithium chemicals through a lithium ion-selective membrane. This approach applies a lithium coating to one of a number of substrates. The process requires a strip coating machine and uses a relatively small area of membrane to achieve the coating. The process suffers from several drawbacks for battery manufacture, which make it unlikely to be unattractive for SSB lithium anode production:
Electrodeposition rates are low, therefore high-volume production requires a large capital investment, resulting in a high all-in cost of production.
The process uses flammable organic electrolytes, which, combined with the tendency of electrolysis systems to spark, creates a fire hazard.
It may be impractical to make large, durable solid electrolytes or ion-selective membranes, which means the production rate from such a machine may not be high, therefore it is unlikely that an economically attractive cost can be achieved.

U.S. Pat. No. 7,390,591 discloses a protected lithium anode formed on a lithium ion-conducting glass substrate by various processes, including physical vapor deposition. The ion-conductive glass is intended to function as a separator and part of a layered solid electrolyte. This process is suitable for manufacturing lithium SSBs with a glass separator, and overcomes the problem associated with lithium reactivity by protecting it from attack by atmospheric gases. However, the disclosed anode has several drawbacks:
It requires a current collector made of copper which is intrinsically expensive and imposes a significant floor cost (see Table 7 for comparison of substrate material costs).
It is suitable for batteries using a glass separator but may not be suitable for other battery designs.

U.S. Pat. No. 5,522,955 discloses a lithium anode and production equipment based on a physical vapor deposition process. The proposed equipment deposits an 8-25 micron thick layer of lithium on copper, nickel, stainless steel, or a conductive polymer. Vapor deposition is an inexpensive process used to produce packaging materials at large scales, and so may be capable of making anodes at an attractive cost. However this disclosure further contemplates the application of an ion-conductive polymer to the anode surface to protect its surface from oxidation and nitridation when it is exposed to air, and to create a partial cell assembly. This second step is done in a separate chamber from that in which the vapor deposition is conducted. This may have some shortcomings, including:
It requires a current collector made of copper which is intrinsically expensive and imposes a significant floor cost (see Table 7 for comparison of substrate material costs).
Other materials proposed by the prior art suffer from comparatively high cost and low electrical conductivity, which reduces cell performance and aggravates plating and stripping problems.
The equipment required to apply the protective coating is complicated and requires a separate processing chamber.

Besides their high cost, metallic lithium anodes have been plagued by issues in operation that undermine the benefits provided by their high energy density. The most prevalent of these is the tendency to form dendrites, especially at high plating current densities (i.e., fast charging). Dendrites are structures that form where preferential lithium plating has occurred, resulting in projections which can penetrate through the separator of a battery cell, leading to short-circuiting, loss of performance, and potentially fires. Other defects of plating include highly-porous or mossy lithium deposits, which are prone to unwanted chemical reactions with the electrolyte, resulting in the consumption of both lithium and electrolyte, and the premature failure of the cell. In cells using liquid electrolytes, even well-formed lithium can suffer from reaction with the electrolyte over time, leading to limitations on cell performance, in terms of cycle life, calendar life, energy density and charging rates.

Several approaches have been developed to address the above issues. For example, US20160233549A1 and US20200194786A1 disclose lithium metal anode cells that utilize specialized electrolytes designed to minimize the reaction between the electrolyte and lithium metal anode, and to suppress dendrite formation. These approaches are at least partly effective, however, exotic electrolytes can burden the battery cell with additional cost and potential trade-offs in other areas of performance and manufacturability.

US20200194786A1 also proposes use foils of lithium metal alloys incorporating between 3-60% magnesium (Mg) in the anode to suppress dendrite and mossy lithium formation. This approach increases the bulk density of the anode material, reducing the energy density of the cell using such an anode because of the large amount of excess material.

Other prior art has proposed using sputtered intermetallic compounds of lithium with gold (Au), zinc (Zn) or zinc oxide (ZnO) on the surface of lithium foils to improve their cycling performance. Such approaches, however, suffer from the minimum thickness limitations and costliness of the lithium foils and compound the problem by introducing costly vacuum processing steps.

While the prior art addresses some of the shortcomings of lithium foil anodes, to date, no effective process for producing low-cost SSB lithium anodes with relatively superior plating and stripping characteristics beyond those of rolled lithium foils has been developed. There remains a need for improved anode assemblies that can be used in lithium-based batteries, and that are sufficiently stable, cost effective for use in disposable and/or consumer-type batteries and that have a desired and sufficient performance. The present disclosure aims to address this hurdle by providing improved, low-cost lithium metal anode assemblies, manufacturing processes, and equipment for their production.

In accordance with one broad aspect of the teachings herein, a multi-layer, lithium anode assembly for use in a lithium-based battery can include a substrate region having a current collector comprising a continuous copper foil that is between 4 and 10 microns thick and has a lithium compatible support surface. A lithium hosting region may overlie the support surface and may include a lithium material film deposited directly onto the support surface via thermal evaporation and having a thickness that is between 1 microns and 10 microns. A cover region may be located outboard of the lithium hosting region may include at least one cover film formed from a passivation material and covering the lithium material film. The cover region may allow a lithium ion flux between an electrolyte and the lithium hosting region and inhibiting irreversible reactions between the lithium hosting region and the electrolyte or surrounding environment.

The passivation material may include at least one of a nitride, a hydride, a carbonate, lithium carbonate, lithium nitride, lithium oxide, lithium sulphide, an oxide, lithium aluminate, a sulphide, gold, platinum, polyethylene oxide, lithium catehcols, and a lithium ion conductive polymer.

The passivation material may include lithium nitride.

The at least one cover film may be formed in situ by exposing a surface of the lithium material film to pure nitrogen gas and facilitating a chemical reaction between the nitrogen and the lithium material film to produce the lithium nitride on the surface of the lithium material film.

An overall assembly thickness of the anode assembly is less than 50 microns.

In accordance with another broad aspect of the present teachings, a multi-layer, lithium anode assembly for use in a lithium-based battery may include a substrate region having a current collector may include a continuous copper foil that is between 4 and 10 microns thick and has a lithium compatible support surface. A lithium hosting region may overlie the support surface and may include a lithium material film deposited directly onto the support surface via thermal evaporation and having a thickness that is between 1 microns and 10 microns. A cover region may be located outboard of the lithium hosting region may have at least one cover film that includes a lithiophilic material deposited directly onto an exposed surface of the lithium material film via physical vapour deposition. The cover region may thereby enhance mobility of lithium ions travelling through the cover region and between an electrolyte and the lithium hosting region so that dendrite formation is inhibited when lithium is deposited in the lithium hosting region when the anode assembly is in use, as compared to providing direct contact between the electrolyte and the lithium material film.

The lithiophilic material may include at least one of tin (Sn), zinc (Zn), magnesium (Mg), carbon (C), indium (In), silver (Ag), bismuth (Bi), lead (Pb).

The lithiophilic material may include a lithium-zinc alloy formed in situ within the anode assembly by depositing zinc directly onto an exposed surface of the lithium material film via physical vapor deposition.

An overall assembly thickness of the anode assembly is less than 50 microns.

In accordance with another broad aspect of the teachings herein, a multi-layer, lithium anode assembly for use in a lithium-based battery may include a substrate region having a current collector that may include a continuous stainless steel foil that is between 3 and 8 microns thick and has a lithium compatible support surface. An interface region may be located between the lithium hosting region and the support surface and may include at least one interface film positioned between the support surface and the lithium hosting region to physically separate the substrate region and the lithium hosting region. The at least one interface film may be formed from copper deposited directly onto the support surface and having a thickness of between 0.5 and 2 microns and allowing an electron flux between the lithium hosting region and the support surface. A lithium hosting region may overlie the interface region and may include a lithium material film deposited directly onto the at least one interface film via thermal evaporation and having a thickness that is between 1 microns and 10 microns. A cover region may be located outboard of the lithium hosting region may have at least one cover film formed from a passivation material and covering the lithium material film. The cover region allowing a lithium ion flux between an electrolyte and the lithium hosting region and inhibiting irreversible reactions between the lithium hosting region and the electrolyte or surrounding environment.

The passivation material may include at least one of a nitride, a hydride, a carbonate, lithium carbonate, lithium nitride, lithium oxide, lithium sulphide, an oxide, lithium aluminate, a sulphide, gold, platinum, polyethylene oxide, lithium catehcols, and a lithium ion conductive polymer.

The passivation material may include lithium carbonate (Li2CO3).

The at least one cover film is formed in situ by exposing a surface of the lithium material film to pure carbon dioxide gas and facilitating a chemical reaction between the carbon dioxide and the lithium material film to produce the lithium carbonate on the surface of the lithium material film.

A overall assembly thickness of the anode assembly is less than 50 microns.

In accordance with another broad aspect of the teachings herein, a multi-layer, lithium anode assembly for use in a lithium-based battery may include a substrate region having a current collector that may include a continuous aluminum foil that is between 5 and 15 microns thick and has a lithium compatible support surface. An interface region may be located between the lithium hosting region and the support surface and may include at least one interface film positioned between the support surface and the lithium hosting region to physically separate the substrate region and the lithium hosting region. The at least one interface film being formed from nickel deposited directly on the support surface, having a thickness of between 200 nm and 400 nm and allowing an electron flux and inhibiting lithium ion flux between the lithium hosting region and the support surface. A lithium hosting region may overlie the interface region and may include a lithium material film deposited directly onto the at least one interface film via thermal evaporation and having a thickness that is between 1 microns and 10 microns. A cover region may be located outboard of the lithium hosting region may have at least one cover film formed from a passivation material and covering the lithium material film. The cover region may allow a lithium ion flux between an electrolyte and the lithium hosting region and inhibiting irreversible reactions between the lithium hosting region and the electrolyte or surrounding environment.

The passivation material may include at least one of a nitride, a hydride, a carbonate, lithium carbonate, lithium nitride, lithium oxide, lithium sulphide, an oxide, lithium aluminate, a sulphide, gold, platinum, polyethylene oxide, lithium catehcols, and a lithium ion conductive polymer.

The passivation material may include lithium carbonate (Li2CO3).

The at least one cover film may be formed in situ by exposing a surface of the lithium material film to pure carbon dioxide gas and facilitating a chemical reaction between the carbon dioxide and the lithium material film to produce the lithium carbonate on the surface of the lithium material film.

An overall assembly thickness of the anode assembly is less than 50 microns.

In accordance with another broad aspect of the teachings herein a multi-layer, lithium anode assembly for use in a lithium-based battery may include a substrate region having a current collector with a continuous aluminum foil that is between 5 and 15 microns thick and has a support surface. An interface region may be located between the lithium hosting region and the support surface and may include at least one interface film to physically separate the substrate region and the lithium hosting region. The at least one interface film may be formed from nickel deposited directly on the support surface, having a thickness of between 200 nm and 400 nm and allowing an electron flux and inhibiting lithium ion flux between the lithium hosting region and the support surface. A lithium hosting region may overlie the interface region and may include a lithium material film deposited directly onto the at least one interface film via thermal evaporation. A cover region located outboard of the lithium hosting region may have a first cover film formed from a lithiophilic material deposited directly onto an exposed surface of the lithium material film via physical vapour deposition. The cover region may enhance mobility of lithium ions travelling through the cover region and between an electrolyte and the lithium hosting region so that dendrite formation is inhibited when lithium is deposited in the lithium hosting region when the anode assembly is in use, as compared to providing direct contact between the electrolyte and the lithium material film.

The lithiophilic material may include at least one of tin (Sn), zinc (Zn), magnesium (Mg), carbon (C), indium (In), silver (Ag), bismuth (Bi), lead (Pb).

The lithiophilic material may include a lithium-zinc alloy formed in situ within the anode assembly by depositing zinc directly onto an exposed surface of the lithium material film via physical vapor deposition.

An overall assembly thickness of the anode assembly is less than 50 microns.

In accordance with another broad aspect of the teaching herein, a multi-layer, lithium anode assembly for use in a lithium-based battery may include substrate region having a lithium compatible support surface and a non-lithium current collector. A lithium hosting region may overlie the support surface and may be configured to retain a least at first lithium material film. An interface region may be located between the lithium hosting region and the support surface and may include at least one interface film positioned between the support surface and the lithium hosting region to physically separate the substrate region and the lithium hosting region. The at least one interface film may be formed by a physical deposition of a lithium compatible material onto the support surface and being electronically conductive to allow an electron flux between the lithium hosting region and the support surface. A cover region may be located outboard of the lithium hosting region may have at least one cover film covering an outboard side of the lithium hosting region. The cover region allowing a lithium ion flux between an electrolyte and the lithium hosting region.

The interface region may be operable to do at least one of inhibiting dendrite formation when lithium is deposited in the lithium hosting region when in use, and improving lithium ion flux or ion distribution between the lithium hosting region and the substrate region when in use;

The cover region may be operable to do at least one of inhibit irreversible reactions between the lithium hosting region and the electrolyte or surrounding environment, inhibit dendrite formation when lithium is deposited in the lithium hosting region when in use, and improving lithium ion flux or ion distribution between the lithium hosting region and the electrolyte when in use.

The anode assembly may include both the interface region and the cover region.

The first lithium material film may be formed by a physical deposition of a lithium compatible material into the lithium hosting region.

The current collector may include at least one of copper, aluminium, nickel, stainless steel, steel, an electrically conductive polymer, a polymer.

The current collector may be configured as a continuous web.

The current collector may have a collector thickness of between about 1 and about 100 microns, and preferably of between about 4 and about 70 microns or between about 5 and 15 microns.

The current collector may be formed from a lithium compatible material and may have a front surface that may include the support surface.

The lithium compatible material may include a metal foil may have at least one of copper, steel, and stainless steel.

The current collector may be formed from a non-lithium compatible material and may include a first protective film bonded to and covering a front surface of the current collector and providing the support surface. The first protective film may be formed from a protective metal that is electronically conductive and resistive to lithium ion flux whereby electrons can travel through the first protective film from the lithium hosting region to the current collector and the lithium hosting region is spaced from and at least substantially ionically isolated from the current collector such that and diffusion of lithium ions from the lithium hosting region to the current collector through the first protective film is substantially prevented.

The protective metal may include at least one of copper (Cu), nickel (Ni), silver (Ag), stainless steel and steel, titanium (Ti), zirconium (Zr), molybdenum (Mo), or alloys thereof.

The non-lithium compatible material may include a metal foil may have aluminum, zinc or magnesium, or alloys thereof

The first protective film may have a thickness of between about 1 and about 75,000 Angstroms, and preferably between about 200 and about 7500 Angstroms.

The first protective film may have an isolation thickness and is shaped so that the current collector is completely ionically isolated from the lithium hosting region.

The first lithium material film may be deposited onto the first protective film via physical vapour deposition and bonds to the first protective film.

The least one interface film may include at least one of tin (Sn), zinc (Zn), magnesium (Mg), carbon (C), copper (Cu), indium (In), silver (Ag), bismuth (Bi), lead (Pb), cadmium (Cd), antimony (Sb) and selenium (Se).

The least one interface film may have a thickness of between about 1 and about 75,000 Angstroms, and preferably between about 200 and about 7500 Angstroms.

The least one interface film may include at least a first deposition-enhancing film may have at least one of tin (Sn), zinc (Zn), magnesium (Mg), carbon (C), indium (In), silver (Ag), bismuth (Bi), lead (Pb) and positioned to contact the lithium hosting region, whereby dendrite formation is inhibited when the first lithium material film is deposited in the lithium hosting region.

The first deposition-enhancing film may be a deposited film formed by a physical deposition of the at least one of tin (Sn), zinc (Zn), magnesium (Mg), carbon (C), indium (In), silver (Ag), bismuth (Bi), lead (Pb) onto an underlying surface.

The interface region further may include at least a first bonding film adjacent the first deposition-enhancing film and may have at least one zinc (Zn), cadmium (Cd), magnesium (Mg), antimony (Sb), indium (In), bismuth (Bi), nickel (Ni), lead (Pb) and selenium (Se) and may be positioned between the support surface and the lithium hosting region thereby providing an improved bond between the support surface and the lithium hosting region than would be achieved between the support surface and the lithium hosting region in the absence of the first bonding film

The least one interface film may include at least a first bonding film may have at least one zinc (Zn), cadmium (Cd), magnesium (Mg), antimony (Sb), indium (In), bismuth (Bi), nickel (Ni), lead (Pb) and selenium (Se) and may be positioned between the support surface and the lithium hosting region thereby providing an improved bond between the support surface and the lithium hosting region than would be achieved between the support surface and the lithium hosting region in the absence of the first bonding film.

The bonding film may be formed by a physical vapour deposition of the at least one zinc (Zn), cadmium (Cd), magnesium (Mg), antimony (Sb), indium (In), bismuth (Bi), nickel (Ni), lead (Pb) and selenium (Se) onto an underlying surface.

The interface region further may include at least a first deposition-enhancing film adjacent the bonding film and may have at least one of tin (Sn), zinc (Zn), magnesium (Mg), carbon (C), indium (In), silver (Ag), bismuth (Bi), lead (Pb) and may be positioned to contact the lithium hosting region, whereby dendrite formation is inhibited when the first lithium material film is deposited in the lithium hosting region.

The interface region may be free of a metal foil.

The lithium hosting region may contain the first lithium material film.

The first lithium material film may be formed by a physical deposition lithium metal onto the support surface.

The assembly may include at least one cover film in the cover region and the first lithium material film may include lithium metal deposited into the lithium hosting region after the at least one cover film is in place.

The lithium hosting region may be free of a lithium foil.

The lithium hosting region may be free of a metal foil.

The at least one cover film may include at least a first passivation film covering an outboard side of the lithium hosting region and inhibiting reactions between the lithium hosting region and the ambient environment. The first passivation film being formed from a passivation material that inhibits gas diffusion and allows lithium ion flux through the first passivation film.

The passivation material may include at least one of a nitride, a hydride, a carbonate, lithium carbonate, lithium nitride, lithium oxide, lithium sulphide, an oxide, lithium aluminate, a sulphide, gold, platinum, polyethylene oxide, lithium catehcols, and a lithium ion conductive polymer.

The passivation material may include lithium carbonate (Li2CO3).

The lithium carbonate may include a film that is formed in situ on a surface of the first lithium material film by exposing the surface to a gas treatment of pure carbon dioxide and reacting lithium material at the surface with the carbon dioxide to form the lithium carbonate.

The cover region may include at least a first deposition-enhancing film formed from a wetting material and covering an outboard side of the lithium hosting region and enhancing wetting between the first wetting film and the lithium hosting region whereby dendrite formation is inhibited when the first lithium material film is deposited in the lithium hosting region thought the first deposition-enhancing film in the cover region.

The at least one cover film may include at least a first deposition-enhancing film formed from a wetting material and covering an outboard side of the lithium hosting region and enhancing wetting between the first deposition-enhancing film and the electrolyte whereby dendrite formation in the lithium hosting region is inhibited when the first lithium material film is deposited in the lithium hosting region through the first deposition-enhancing film to reach the lithium hosting region.

The wetting material may include polyethylene oxide (PEO).

The polyethylene oxide may be deposited via physical vapour deposition and bonds to an adjacent film.

The polyethylene oxide may be deposited onto the first lithium material film.

The polyethylene oxide may be deposited onto and bonded to an intervening transfer film that is provided between the first deposition-enhancing film and the first lithium material film and that enhances charge transfer to and from the first lithium material film.

The transfer film may include at least one of tin (Sn), zinc (Zn), magnesium (Mg), carbon (C), indium (In), silver (Ag), bismuth (Bi), lead (Pb)

The cover region may include at least a first passivation film covering an outboard side of the lithium hosting region and inhibiting reactions between the lithium hosting region and the ambient environment. The first passivation film may be formed from a passivation material that inhibits gas diffusion and allows lithium ion flux through the first passivation film.

The cover region may include at least a lithiophilic cover film covering an outboard side of the lithium hosting region and may include at least one of tin (Sn), zinc (Zn), magnesium (Mg), carbon (C), indium (In), silver (Ag), bismuth (Bi), lead (Pb), whereby a lithiophilic cover film enhances mobility of lithium ions travelling through the lithiophilic cover film and between an electrolyte and the lithium hosting region so that dendrite formation is inhibited when lithium is deposited in the lithium hosting region when the anode assembly is in use.

The cover region may be free of a metal foil.

The anode assembly may be free of lithium metal foil.

The current collector may include a non-lithium metal foil and may be the only foil in the anode assembly.

The anode assembly may have an assembly thickness that is less than about 60 μm.

The assembly thickness may be less than about 50 μm.

The assembly thickness may be between about 10 μm and about 50 μm.

The assembly thickness may be between about 15 μm and about 30 μm.

The assembly thickness may be between about 16 and about 25 μm.

The anode assembly may have an areal density of less than about 80 g/m2.

The areal density may be less than about 70 g/m2

The areal density may be less than about 60 g/m2.

The areal density may be between about 30 g/m² and 70 g/m2.

The areal density may be between about 40 g/m² and 65 g/m2.

In accordance with another broad aspect of the teachings herein, a single-pass method of manufacturing a multi-layer anode assembly for use in a lithium-based battery, the method may include the steps of:
a) unwinding a continuous substrate web from a substrate feed roll and conveying the substrate web in a process direction along a deposition path within a processing chamber of a single-pass physical vapor deposition apparatus, the substrate web may include a continuous current collector and a lithium compatible support surface disposed on a first side of the current collector;
b) conveying the substrate web in the process direction through a lithium deposition zone along the deposition path and depositing at least a first lithium film onto the assembly outboard of the support surface using a lithium physical vapour deposition applicator;
at least one of steps:
c) conveying the substrate web in the process direction through an interface deposition zone that is along the deposition path and upstream from the lithium deposition zone, and depositing a first interface film formed from an interface material onto the support surface using an interface physical vapour deposition applicator whereby the first interface film is between the support surface and the first lithium film, the interface material being electronically conductive to allow an electron flux between the first lithium film and the support surface; and
d) conveying the substrate web in the process direction through a cover deposition zone that is along the deposition path and downstream from the lithium deposition zone, wherein a first cover film is formed from a cover material that allows a lithium ion flux between an electrolyte and the first lithium film and is outboard of the first lithium film whereby the first lithium film is between the first cover film and support surface; thereby forming a multi-layer anode assembly; and
e) after performing steps b) and the at least one of steps c) and d), winding the multi-layer anode assembly about an output roll at an outlet of the deposition path and wherein at least steps b) and the at least one of steps c) and d) are completed during a single pass of the substrate web through the deposition path.

Steps b) and the at least one of steps c) and d) may be completed during a single PVD vacuum cycle in which the processing chamber remains at an operating pressure that is less than 10-2 Torr during steps b) and the at least one of steps c) and d).

The current collector may include a continuous metal foil.

The current collector may have a thickness of between about 1 and about 100 microns.

The current collector may include at least one of copper, aluminium, magnesium, nickel, stainless steel, steel, an electrically conductive polymer and a polymer.

The current collector may include a lithium compatible metal foil, and a front surface of the current collector may provide the support surface. The first lithium film may be deposited directly onto the front surface of the current collector by the lithium physical vapour deposition applicator.

The current collector may include a non-lithium compatible metal foil, and the method further may include conveying the substrate web in the process direction through a protective layer deposition zone upstream from the lithium deposition zone and forming a first protective film by directly depositing a lithium compatible protective material onto a front side of the current collector via a protective film vapour deposition applicator, wherein the protective material is electronically conductive and resistive to lithium ion flux whereby electrons can travel through the first protective film from the first lithium film to the current collector and the first lithium film is spaced from and at least substantially ionically isolated from the current collector such that diffusion of lithium ions from the lithium hosting region to the current collector through the first protective film is substantially prevented, and wherein the first protective film may include the support surface, and the first lithium film is deposited directly onto the first protective film.

The protective material may include at least one of copper, nickel, silver, stainless steel and steel, titanium, zirconium, molybdenum or alloys thereof.

The first cover film may be formed by depositing a first cover material onto the first lithium film using a cover physical vapour deposition applicator.

The first cover film may be a lithiophilic cover film may include at least one of tin (Sn), zinc (Zn), magnesium (Mg), carbon (C), indium (In), silver (Ag), bismuth (Bi), lead (Pb), whereby the lithiophilic cover film enhances diffusion of lithium ions travelling through the lithiophilic cover film a between an electrolyte and the lithium hosting region so that dendrite formation is inhibited when lithium is deposited in the lithium film when the anode assembly is in use.

The first cover film may be formed in situ by a performing a gas treatment on a surface of the first lithium film, thereby forming a first cover material.

The first cover material may include at least one of a nitride, a hydride, a carbonate, lithium carbonate, lithium nitride, lithium oxide, lithium sulphide, an oxide, lithium aluminate, a sulphide, gold, platinum, polyethylene oxide, lithium catehcols, and a lithium ion conductive polymer, whereby the first cover film allows a lithium ion flux between an electrolyte and the first lithium film and inhibits irreversible reactions between the first lithium film and the electrolyte or surrounding environment.

Steps b) and the at least one of steps c) and d) may be carried out while the substrate web is moving between the input roll and the output roll at a processing speed that is between about 1m/min and about 100m/min, and preferably is between 2m/min and 50m/min.

The processing chamber may be substantially free of oxygen during steps b) and the at least one of steps c) and d).

The operating pressure may be between about 10-2 and 10-6 Torr.

The method may include, prior to step b) reducing the pressure in the interior of the metalizing chamber from generally atmospheric pressure to the operating pressure.

The method may include both step c) and d), and step c) may be performed before step b).

After completing step b) and the at least one of steps c) and d), but before completing step e), the method further may include:
f) conveying the substrate web in the process direction through a second lithium deposition zone along the deposition path and depositing at least a second lithium film onto a second support surface that is disposed on an opposing second side of the current collector using a lithium physical vapour deposition applicator; and
at least one of steps:
g) conveying the substrate web in the process direction through a second interface deposition zone that is along the deposition path and upstream from the second lithium deposition zone, and depositing a second interface film formed from the interface material onto the second support surface using an interface physical vapour deposition applicator whereby the second interface film is between the second support surface and the second lithium film, the interface material being electronically conductive to allow an electron flux between the second lithium film and the second support surface; and
h) conveying the substrate web in the process direction through a second cover deposition zone that is along the deposition path and downstream from the second lithium deposition zone, wherein a second cover film is formed from the cover material that allows a lithium ion flux between an electrolyte and the second lithium film and is outboard of the second lithium film whereby the second lithium film is between the second cover film and second support surface; and
wherein step f) and the at least one of steps g) and h) are performed completed during the single pass of the substrate web through the deposition path, and step e) is performed after step h).

In accordance with another broad aspect of the teachings herein a multi-layer anode assembly may be formed using any of the methods or portions of the methods described herein and all of the films may be deposited using physical vapour deposition.

In accordance with another broad aspect of the teachings herein, a single-pass method of manufacturing a multi-layer anode assembly for use in a lithium-based battery may include the steps of:
a) unwinding a continuous substrate web from a substrate feed roll and conveying the substrate web in a process direction along a deposition path within a processing chamber of a single-pass physical vapor deposition apparatus, the substrate web may include a continuous current collector and a lithium compatible support surface disposed on a first side of the current collector;
b) conveying the substrate web in the process direction through an interface deposition zone that is along the deposition path, and depositing a first interface film formed from an interface material onto the support surface using an interface physical vapour deposition applicator, the interface material being electronically conductive to allow an electron flux between the first lithium film and the support surface;
c) conveying the substrate web in the process direction through a lithium deposition zone that is along the deposition path and downstream from the interface deposition zone and depositing at least a first lithium film onto the first interface film a lithium physical vapour deposition applicator, whereby the first interface film is between the support surface and the first lithium film;
d) conveying the substrate web in the process direction through a cover deposition zone that is along the deposition path and downstream from the lithium deposition zone, wherein a first cover film is formed from a cover material that allows a lithium ion flux between an electrolyte and the first lithium film and is outboard of the first lithium film whereby the first lithium film is between the first cover film and support surface;
i) conveying the substrate web in the process direction through a second interface deposition zone that is along the deposition path and downstream from the cover deposition zone, and depositing a second interface film formed from the interface material onto a second support surface that is disposed on an opposing second side of the current collector using a second interface physical vapour deposition applicator;
j) conveying the substrate web in the process direction through a second lithium deposition zone that is along the deposition path and downstream from the second interface deposition zone and depositing at least a second lithium film onto the second interface film using a lithium physical vapour deposition applicator; and
k) conveying the substrate web in the process direction through a second cover deposition zone that is along the deposition path and downstream from the second lithium deposition zone, wherein a second cover film is formed from the cover material that allows a lithium ion flux between an electrolyte and the second lithium film and is outboard of the second lithium film whereby the second lithium film is between the second cover film and second support surface, thereby providing a two-sided, multi-layer anode assembly;
l) after performing steps a) to k) winding the two-sided multi-layer anode assembly about an output roll at an outlet of the deposition path;
and at least a) to k) are completed during a single pass of the substrate web through the deposition path.

In accordance with another broad aspect of the teachings described herein, single-pass method of manufacturing a two-sided, multi-layer anode assembly for use in a lithium-based battery may include the steps of:
a) unwinding a continuous substrate web from a substrate feed roll and conveying the substrate web in a process direction along a deposition path within a processing chamber of a single-pass physical vapor deposition apparatus, the substrate web may include a continuous current collector having a first side and an opposing second side;
b) conveying the current collector in the process direction while applying at least first and second films on the first side of the current collector using respective first and second physical vapour deposition applicators positioned to face the first side of the current collector;
c) conveying the current collector in the process direction while applying at least third and fourth films on the second side of the current collector using respective third and fourth physical vapour deposition applicators positioned to face the second side of the current collector, wherein steps b) and c) are completed during a single pass of the substrate web through the deposition path thereby providing a two-sided, multi-layer anode assembly; and
d) after performing steps b) and c) winding the two-sided multi-layer anode assembly about an output roll at an outlet of the deposition path.

The first film may include a first lithium film formed from a lithium material, and wherein the second film may include at least one of:
a) an interface film that is inboard of the lithium film that is configured to inhibit dendrite formation when lithium is deposited in the lithium film and/or improve a lithium ion flux or ion distribution between the first lithium film and current collector, and that is formed from an interface material that may include at least one of tin (Sn), zinc (Zn), magnesium (Mg), carbon (C), copper (Cu), indium (In), silver (Ag), bismuth (Bi), lead (Pb), cadmium (Cd), antimony (Sb) and selenium (Se); and
b) a cover film that is outboard of the first lithium film and is formed from i) a passivation material that is configured to inhibiting reactions between the first lithium film and the ambient environment by inhibiting gas diffusion while allowing lithium ion flux through the cover film, or ii) a lithiophilic cover material configured to enhance mobility of lithium ions travelling through the cover film a between an electrolyte and the first lithium hosting region so that dendrite formation is inhibited when lithium is deposited in the first lithium film when the anode assembly is in use.

The passivation material may include at least one of a nitride, a hydride, a carbonate, lithium carbonate, lithium nitride, lithium oxide, lithium sulphide, an oxide, lithium aluminate, a sulphide, gold, platinum, polyethylene oxide, lithium catehcols, and a lithium ion conductive polymer.

The lithiophilic cover material may include at least one of tin (Sn), zinc (Zn), magnesium (Mg), carbon (C), indium (In), silver (Ag), bismuth (Bi), lead (Pb).

The third film may include a second lithium film formed from the lithium material, and wherein the fourth film may include at least one of:
a) an interface film that is inboard of the lithium film that is configured to inhibit dendrite formation when lithium is deposited in the lithium film and/or improve a lithium ion flux or ion distribution between the first lithium film and current collector, and that is formed from an interface material that may include at least one of tin (Sn), zinc (Zn), magnesium (Mg), carbon (C), copper (Cu), indium (In), silver (Ag), bismuth (Bi), lead (Pb), cadmium (Cd), antimony (Sb) and selenium (Se); and
b) a cover film that is outboard of the first lithium film and is formed from i) a passivation material that is configured to inhibiting reactions between the first lithium film and the ambient environment by inhibiting gas diffusion while allowing lithium ion flux through the cover film, or ii) a lithiophilic cover material configured to enhance mobility of lithium ions travelling through the cover film a between an electrolyte and the first lithium hosting region so that dendrite formation is inhibited when lithium is deposited in the first lithium film when the anode assembly is in use.

The passivation material may include at least one of a nitride, a hydride, a carbonate, lithium carbonate, lithium nitride, lithium oxide, lithium sulphide, an oxide, lithium aluminate, a sulphide, gold, platinum, polyethylene oxide, lithium catehcols, and a lithium ion conductive polymer.

The lithiophilic cover material may include at least one of tin (Sn), zinc (Zn), magnesium (Mg), carbon (C), indium (In), silver (Ag), bismuth (Bi), lead (Pb).

In accordance with another broad aspect of the teachings herein, a method of manufacturing a multi-layer anode assembly for use in a battery may include:
a) unwinding a continuous substrate web from a substrate feed roll and conveying the substrate web in a process direction along a deposition path within a processing chamber of a single-pass physical vapor deposition apparatus, the substrate web may include a continuous current collector and a lithium compatible support surface;
at least one of steps:
b) conveying the substrate web in the process direction through an interface deposition zone that is along the deposition path, and depositing a first interface film formed from an interface material onto the support surface using an interface physical vapour deposition applicator, the interface material being electronically conductive to allow an electron flux through the first interface film; and
c) conveying the substrate web in the process direction through a cover deposition zone that is along the deposition path and downstream from the interface deposition zone, and forming a first cover film outboard of the support surface, the first cover film being formed from a cover material that is conductive to lithium ions to allow a lithium ion flux through the first cover film;
wherein the at least one of steps b) and c) is completed during a single pass of the substrate web along the deposition path, thereby providing an intermediary web assembly, and further may include:
d) positioning at least a first portion of the intermediary web assembly in electrochemical cell may include a positive electrode and a lithium source; and
e) applying an electric potential between the positive electrode and the first portion of the intermediary web whereby lithium ions are driven from the lithium source and are deposited as a first lithium film in a lithium hosting region on the intermediary web assembly that is outboard of the support surface.

The assembly may be free of lithium until step e) is performed.

The at least one of steps b) and c) may be completed during a single PVD vacuum cycle in which an interior of the processing chamber is maintained at an operating pressure that is less than 10-2 Torr.

The current collector may include a continuous metal foil.

The current collector may have a thickness of between about 1 and about 100 microns.

The current collector may include at least one of copper, aluminium, magnesium, nickel, stainless steel, steel, an electrically conductive polymer and a polymer.

The current collector may include a lithium compatible metal foil, and a front surface of the current collector provides the support surface, and the first lithium film is deposited directly onto the front surface of the current collector by the lithium physical vapour deposition applicator.

The current collector may include a non-lithium compatible metal foil, and the method may include conveying the substrate web in the process direction through a protective layer deposition zone upstream from the lithium deposition zone and forming a first protective film by directly depositing a lithium compatible protective material onto a front side of the current collector via a protective film vapour deposition applicator. The protective material may be electronically conductive and resistive to lithium ion flux whereby electrons can travel through the first protective film from the first lithium film to the current collector and the first lithium film is spaced from and at least substantially ionically isolated from the current collector such that diffusion of lithium ions from the lithium hosting region to the current collector through the first protective film is substantially prevented, and wherein the first protective film may include the support surface. The first lithium film may be deposited directly onto the first protective film.

The protective material may include at least one of copper, nickel, silver, stainless steel and steel, titanium, zirconium, molybdenum or alloys thereof.

The first cover film may be formed by depositing a first cover material using a cover physical vapour deposition applicator before the first lithium film is added.

The first cover film may be a lithiophilic cover film may include at least one of tin (Sn), zinc (Zn), magnesium (Mg), carbon (C), indium (In), silver (Ag), bismuth (Bi), lead (Pb), whereby the lithiophilic cover film enhances mobility of lithium ions travelling through the lithiophilic cover film a between an electrolyte and the lithium hosting region so that dendrite formation is inhibited when lithium is deposited in the lithium film when the anode assembly is in use.

The first cover film may be formed in situ by a performing a gas treatment on a surface of the first lithium film, thereby forming a first cover material.

The first cover material may include at least one of a lithium zinc alloy, lithium carbonate, and lithium nitride, whereby the first cover film allows a lithium ion flux between an electrolyte and the first lithium film and inhibits irreversible reactions between the first lithium film and the electrolyte or surrounding environment.

The at least one of steps c) and d) may be carried out while the substrate web is moving between the input roll and the output roll at a processing speed that is between about 1m/min and about 100m/min, and preferably is between 2m/min and 50m/min.

The processing chamber may be substantially free of oxygen during the at least one of steps b) and c).

The operating pressure may be between about 10-2 and 10-6 Torr.

The method may include, prior to step c) reducing the pressure in the interior of the metalizing chamber from generally atmospheric pressure to the operating pressure.

The method may also include at least one of:
f) conveying the substrate web in the process direction through a second interface deposition zone that is along the deposition path, and depositing a second interface film formed from the interface material onto an opposing second side of the substrate web support surface using a second interface physical vapour deposition applicator; and
g) conveying the substrate web in the process direction through a second cover deposition zone that is along the deposition path and downstream from the second interface deposition zone, and forming a second cover film outboard of second side of the substrate web, the second cover film being formed from the cover material;
wherein the at least one of steps b) and c) and the least one of steps f) and g) are completed during the single pass of the substrate web along the deposition path, thereby providing a two-sided intermediary web assembly prior to step d).

The method may include steps b) and c) and f) and g).

### BRIEF DESCRIPTION OF THE DRAWINGS

Embodiments of the present invention will be described with reference to the accompanying drawings, wherein like reference numerals denote like parts, and in which:

FIG. 1 is a partially exploded, schematic representation of a multi-layer anode assembly;

FIG. 2 is schematic representation of one example of an anode assembly for use with lithium-based batteries;

FIG. 3 is an enlarged view of a portion of the anode assembly of FIG. 2;

FIG. 4 is perspective view of the anode assembly of FIG. 2;

FIG. 5 is schematic representation of another example of an anode assembly for use with lithium-based batteries;

FIG. 6 is a flow chart showing one example of a method of manufacturing an anode assembly;

FIG. 7 is a flow chart showing another example of a method of manufacturing an anode assembly;

FIG. 8 is a flow chart showing another example of a method of manufacturing an anode assembly;

FIG. 9 is a schematic representation of one example of a battery containing the anode assembly of FIG. 2;

FIG. 10 is a schematic representation of one example of an apparatus for manufacturing an anode assembly;

FIG. 11 is a cross-sectional view taken along line D in FIG. 10;

FIG. 12 is a cross-sectional view taken along line C in FIG. 10;

FIG. 13 is a schematic representation of one example of a double-sided anode assembly.

FIG. 14 is a schematic representation of another example of an anode assembly;

FIG. 15 is a schematic representation of another example of an anode assembly;

FIG. 16 is a schematic representation of another example of an apparatus for manufacturing an anode assembly;

FIG. 17 is a schematic representation of another example of an apparatus for manufacturing an anode assembly;

FIG. 18 is a schematic representation of another example of an apparatus for manufacturing an anode assembly;

FIG. 19 is a schematic illustration of one example of a battery cell;

FIG. 20 is a schematic representation of another example of an anode assembly;

FIG. 21 is a schematic representation of yet another example of an anode assembly;

FIG. 22 is a schematic illustration of one example of a battery cell including an anode assembly without a lithium reactive layer;

FIG. 23 is the battery cell of FIG. 22 in a charged configuration;

FIG. 24 is a schematic representation of another example of an apparatus for manufacturing an anode assembly;

FIG. 25 is a schematic representation of another example of an apparatus for manufacturing an anode assembly;

FIG. 26 is a schematic representation of another example of an apparatus for manufacturing an anode assembly;

FIG. 27 is a plot showing cycling data for conventional foil and for material according to example 4 showing similar performance;

FIG. 28 is a photograph of a conventional foil after symmetric cycling for 50 cycles using sulphide electrolyte (white particles are electrolyte residue); and

FIG. 29 is a photograph of an example of a PVD deposited lithium after symmetric cycling for 50 cycles using sulphide electrolyte (white particles are electrolyte residue).

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

The teachings described herein aim to provide a suitable multi-layer lithium anode assembly that can reduce and/or eliminate the need for the use of a lithium foil by providing an anode assembly that incorporates one or more functional film layers to help provide relatively improved/superior plating and stripping characteristics that can be manufactured at a relatively low cost and relatively large scale. That is, the present teachings relate to a multi-layer anode assembly that can be suitable for use in liquid electrolyte metal lithium ion batteries (LMB), hybrid lithium metal batteries (HLB) and lithium metal solid-state batteries (SSB), and to a process and apparatus/equipment that can be used for its manufacture. The multi-layer assemblies can include at least two or more regions that can have different functionality, and in which a variety of different layers can be grouped to help provide anode assemblies with a desired range of mechanical and electrical operating capabilities. Preferably, the multi-layer anode is configured to include only one metal foil layer/substrate (such as a current collector foil), and the remainder of the layers (in their respective functional regions) are deposited onto the foil layer using material deposition and/or surface reaction techniques (such as plating, physical vapour deposition and the like) rather than being provided as separate foils or webs that need to be bonded to the base foil layer. As distinct from applying a metal foil or other type of pre-fabricated layer or planar structure, the functional layers described herein are described as films as they are formed by depositing a plurality of smaller material particles onto an underlying surface or substrate (such as by physical vapour deposition), by plating metal onto an underlying surface or substrate, or by facilitating a gas surface reaction on the surface/substrate, or the like. The skilled person would recognize that these films are formed as part of the fabrication process, rather than having pre-made, solid layers of material that are joined together. It is possible that a given film may be formed from two or more distinct layers or may be formed in two or more steps/applications of materials, particularly if formed by successive physical deposition steps. The term film is used for convenience in this specification, and includes structures/layers that are formed using the techniques and processes described herein, as well as other suitable alternatives.

Such anodes, with different functional regions and films deposited in the manner described herein, are understood to be different than known anodes which can technically include, for example, regions where a desired component thickness is created by providing two or more layers of a given foil material, or where different plies of metallic foils are laminated together to provide a generally homogeneous foil structure. The present anode assemblies are also distinguished from anode assemblies that include only a current collector (either protected with a protective layer or unprotected) in combination with a lithium material film, as such assemblies could include versions of a substrate region (either just the current collector or current collector plus one or more protective film coatings) and a lithium hosting region, but would not include a functionally identifiable interface region or cover region as described herein.

Some aspects of the present disclosure can also relate to the production of relatively lower cost lithium anode assemblies for use in one or more types of lithium-based batteries. The present teachings can also relate to a relatively low-cost production of roll-to-roll metallized substrates that can be used in the anode assemblies. According to certain non-limiting embodiments, the present disclosure may disclose a low-cost lithium anode and current collector assembly, a process for producing such an assembly, and physical vapor deposition equipment on which such a process can be operated. The teachings may also relate to batteries that include examples of the anode assemblies described herein.

In accordance with one embodiment described herein, an anode assembly for use in a lithium-based battery can include a current collector substrate that includes aluminum and has a support surface that is intended to receive/support other components of the assembly. A reactive film that includes lithium metal is configured to contact an electrolyte within the battery when the anode assembly is in use and is generally supported by the current collector substrate. To help reduce the chances of an unwanted reaction between the reactive lithium film and the aluminum in the current collector, the assembly can also include a suitable protective film that is bonded to and covers the support surface and includes a protective metal that is suitably electrically conductive. In this arrangement the protective film is disposed between the support surface and the reactive film so that electrons can travel from the first reactive film to the current collector (e.g. to allow an electron flux between the support surface and reactive film) and the first reactive film is spaced from and at least substantially ionically isolated from the support surface. The protective film can therefore help at least substantially prevent or inhibit, and may completely prevent diffusion of the reactive film to the current collector which can help at least substantially inhibit, and optionally completely prevent unwanted reactions between the lithium metal and the current collector. This type of isolation between the current collector substrate and the reactive film may help facilitate the use of lithium in the reactive film while helping to facilitate the use of a material in the current collector that may be generally desirable to use as a current collector but that would otherwise (e.g. in the absence of a suitable protective film) react with the lithium in the reactive film in a manner that reduces the effectiveness of the anode assembly and/or that may damage or reduce the usefulness of the anode assembly or its sub-layers.

In accordance with another broad aspect of the teachings described herein, a protected current collector sub-assembly that can be used in a variety of different anode assemblies, using different reactive materials, may include a current collector substrate that is at least partially covered with one or more suitable protective films (that can optionally be deposited in the substrate region and/or interface region) that is bonded to and covers the front surface of the current collector and includes a protective metal or combination of metals that is suitably electrically conductive and may have other desirable attributes. In this arrangement the protective film is disposed between the current collector and the reactive film so that electrons can travel from the first reactive film to the current collector and the first reactive film is spaced from and at least substantially ionically isolated from the front surface of the current collector. The protective film(s) can therefore help at least substantially prevent or inhibit, and may completely prevent diffusion of the reactive film to the current collector which can help at least substantially inhibit, and optionally completely prevent unwanted reactions between the lithium metal or other such reactive materials that may be present in the reactive film-either at the time of initial construction/assembly of the anode assembly or materials that may be accumulated within the reactive film when the battery is charged and/or in use, and the protected current collector material.

As used herein, the term film or layer describes the amount of a given material, such as the protective material, a gas protection layer material, a conductivity film material, a performance enhancing film material, and the like, that is generally continuous and is not interrupted by intervening materials or structures. Any given film or layer may be formed by a single application of the or the material (e.g. a single pass of a physical vapour deposition process as described herein) that applies all of the material for a film of a given thickness in a single step or process. Alternatively, a single film as described herein may also be formed as the result/combination of two or more applications of the film material (e.g. via multiple passes of a physical vapour deposition process as described herein) that each apply a portion of the film material and the total film thickness is measured on the film formed by accumulating the material from the two or more applications.

In accordance with another broad aspect of the teachings described herein, at least some of the anode assemblies are configured as multi-layer anode assemblies, or components thereof (such as protected current collectors, substrates and the like) in which the particular combination of layers and films that are included, and the order in which they are applied during the manufacturing process may differ based on a variety of factors including cost, mechanical and/or electrical properties, intended uses of the assemblies and the like. For example, some anode assemblies may benefit from protective outer films that can help reduce oxidation of the functional portions of the assemblies during or after manufacture, some anode assemblies may benefit from intermediary films between the reactive lithium films and the underlying current collector to help reduce unwanted reactions or to help enhance electrical conductivity and/or property-matching or bonding between the two dissimilar materials, while yet other anodes may benefit from including lithiophilic films that are generally compatible with lithium metal and can help provide the ion mobility/deposition enhancement effects described herein.

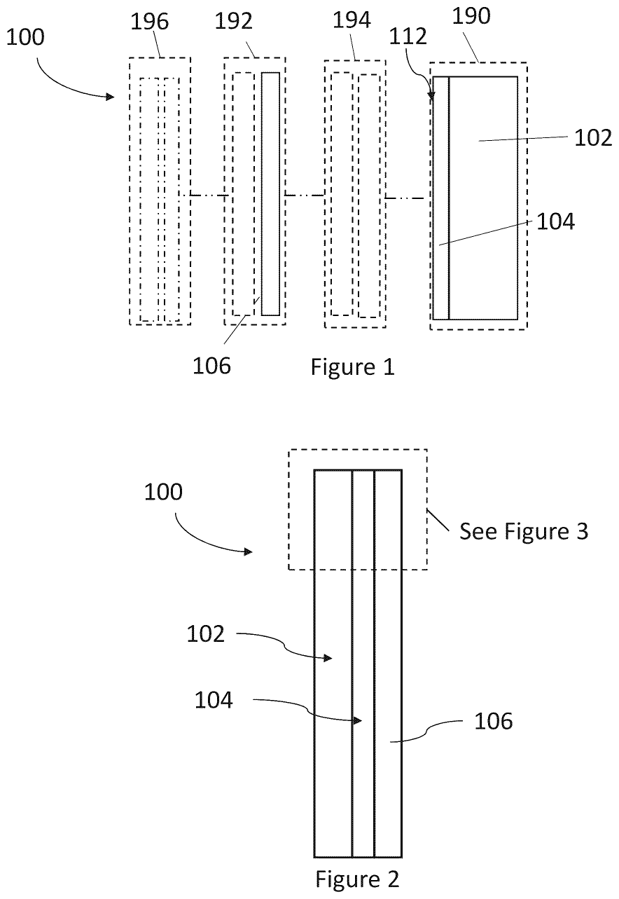

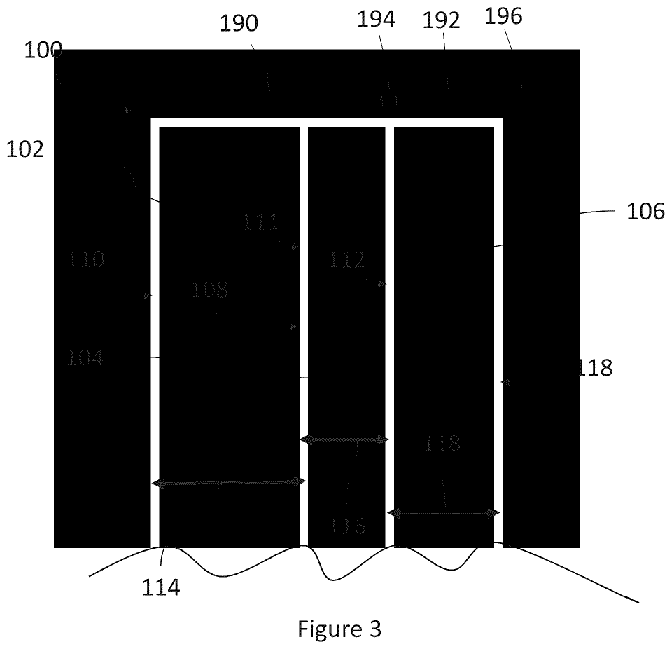

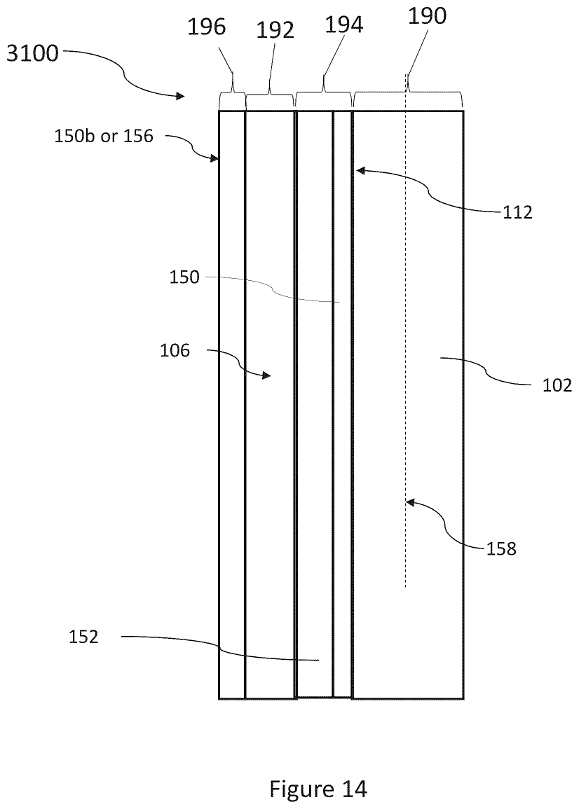

Referring to FIG. 1, one schematic illustration of the arrangement of respective functional regions for a given anode assembly, with the elements partially exploded from each other for clarity, includes a substrate region 190, a lithium hosting region 192, an interface region 194 and a cover region 196 which are illustrated schematically using dashed lines. Each region 190, 192, 194 and 196 can include suitable films of material as described herein. Referring also to FIGS. 2 and 3, in this example the substrate region includes a current collector 102 and its protective coating film 104, the lithium hosting region includes a film of reactive lithium material 106, with the interface and cover regions 194 and 196 are empty (as symbolized using the internal, dashed boxes). In other examples, such as the embodiment of FIG. 14, substrate region 190 includes the current collector 102, lithium hosting region 192 includes the reactive lithium film 106, the interface region includes two different interface films (a performance film 150 and conductivity film 152) and the cover region includes a passivation or gas protection film 156. While this schematic is illustrated as a one-side anode in FIG. 1, it is understood that the same arrangement of regions could be provided on the other side of the substrate region to provide a two-sided anode as described herein.

In general, the substrate region of an anode assembly can be understood to be the base substrate or web of material that helps provide the mechanical strength of the anode assembly and is a base upon which the other regions and films can be deposited/built. The substrate region will include at least a current collector, which can be a suitable metallic foil as described herein. The metallic foil web can be provided on a source or supply roll and can be fed through a suitable processing apparatus via which one or more functional films/layers can be deposited onto a suitable support surface of the foil web, and the resulting layered material can then be wound upon an intermediary or product roll for storage or further processing. In some examples described herein, such as where the current collector is generally compatible with the other films in the anode assembly, the substrate region may include only the current collector. Alternatively, the substrate region may also include one or more protective films that can be applied to the support surface of the current collector to help form at least part of the structure of a protected current collector that can be utilized in assemblies where the material of current collector may react with other components of the assembly in an unwanted manner.

As used herein, a protected current collector is understood to refer to a multi-layer structure that does not include lithium metal or lithium hosting material at the time of its manufacture and that includes a metal foil current collector that is formed from a material that is non-lithium compatible, meaning that the metal foil will tend to react to lithium in a manner that makes in unsuitable for the intended uses described herein, such as aluminum, zinc, magnesium or other lithiophilic materials and their alloys. In addition the non-lithium compatible foil web, a protected current collector will include at least one protective film (such as film 104 described herein) that helps mitigate the potential reactivity between the non-lithium compatible foil web and any lithium material that is eventually added to the anode assembly. Those two films may also define the substrate region for a given assembly. In addition to the protective film in the substrate region, a protected current collector may also include one or more other suitable films as described herein, and may have at least one film present in the interface region 194 and/or cover region 196. Materials that do not tend to react with lithium in these adverse ways, such as copper, steel and stainless steel, can be referred to as lithium compatible materials/foils.

Whether the assembly includes a protected current collector or an unprotected/uncoated current collector, the lithium hosting region 192 can be understood to be the region of the anode assembly that is outboard from and overlies a support surface (such as surface 112) of the substrate region 190. The material in the lithium hosting region 192 may be deposited onto the film(s) of material in the interface region 194 (if present) or, in the absence of any layers of material in the interface region 194, the material in the lithium hosting region 192 may be directly deposited onto the substrate region 190. This may include having lithium material in direct contact with a compatible current collector, or having the lithium material in contact with the protective film (such as film 104).

Defined as the region between the lithium hosting region and the substrate region, the interface region 194 can include one or more layers of suitable interface materials that can provide a variety of functions within the anode assembly. For example, the interface films can have performance enhancing characteristics, they may be lithium ion blocking and electronically conductive (e.g. to allow an electron flux through the interface film and interface region), they may be electronically conductive but not lithium ion blocking, they may be lithiophilic or plating-enhancing, and may help facilitate bonding or other property-matching between adjacent layers, films or regions such as thermal expansion matching, improving bonding between layer, etc.

For example, some materials such may not bond directly to each on in an acceptable manner if one is deposited onto the other as described herein. To help overcome this challenge, an intervening interface film can be provided and can be formed out of a material that can bond satisfactorily with both of the original materials. Similarly, if two materials with significantly different thermal expansion characteristics are bonded directly to each other the force/strain at the interface of the materials during a significant temperature change may be undesirably high and may lead to failure of the connection, damage to at least one of the layers or the like. However, if an intervening layer, with intermediate thermal expansion properties is bonded between the two original layers the amount of force or strain experienced at each interface may be reduced to acceptable levels.

Examples of materials that can be suitable for use as an interface material and can have deposition-enhancing and lithiophilic properties (and for forming films within the interface region) can include, for example, tin (Sn), zinc (Zn), magnesium (Mg), carbon (C), indium (In), silver (Ag), bismuth (Bi), lead (Pb). Examples of materials that can be suitable for use as a lithium ion flux-inhibiting interface material that are electronically conductive (to facilities electron transfer) and can help block lithium ion flux (and for forming a flux-inhibiting or protective film within the interface region or optionally within the substrate region) can include, for example, copper (Cu), nickel (Ni), chromium (Cr), tungsten (W), tantalum (Ta), iron (Fe), titanium (Ti), zirconium (Zr), molybdenum (Mo) and alloys thereof. Examples of materials that can be suitable for use as an interface material and can help provide property-matching and/or improved material bonding properties (and for forming a layer within the interface region) can include, for example, zinc (Zn), cadmium (Cd), copper (Cu), magnesium (Mg), antimony (Sb), indium (In), bismuth (Bi), nickel (Ni), lead (Pb) and selenium (Se).

The cover region 196 can include any films, coatings or other materials that are located outboard of the lithium hosting region, and at least one of which will end up serving as an outermost layer or surface of the anode assembly. The films in the cover region can include, for example, passivation films (configured to inhibit irreversible reactions between the lithium hosting region and the electrolyte or surrounding environment, such as by inhibiting gas diffusion and allowing lithium ion flux through the first passivation film), deposition-enhancing films (configured to improve lithium ion flux or ion distribution between the lithium hosting region and the electrolyte when in use), lithiophilic cover films (configured to help enhance transfer of lithium ions so that dendrite formation is inhibited when lithium is deposited in the lithium hosting region when the anode assembly is in use). Some examples of materials that can be used to form deposition-enhancing and/or lithiophilic films in the cover region can include, for example, tin (Sn), zinc (Zn), magnesium (Mg), carbon (C), indium (In), silver (Ag), bismuth (Bi) and lead (Pb). Some examples materials that can be used to form passivation films in the cover region can include, nitrides (such as lithium nitride), hydrides (such as lithium hydride), carbonates (such as lithium carbonate), oxides (such as lithium oxide), sulphides (such as lithium sulphide), lithium-ion conducting polymers (such as PEO and lithium catehcols), gold (Au), platinum (Pt) and the like.

As shown above, some films/materials can be included in two or more distinct layers, optionally in different regions 190, 192, 194 or 196 within a single anode assembly. The material used in the films may provide substantially the same function (such as enhancing plating by reducing dendrite formation, or combinations of functions such as inhibiting unwanted reactions and improving lithium ion transport, etc.) in each region, or may provide a different function within the assembly based on its location. For example, zinc (Zn) or magnesium (Mg) may be used in at least one interface film within the interface region to help provide mechanical/chemical property matching between the current collector and the material in the lithium hosting region

While different anode assemblies may have different combinations of the different types of films described herein, and different numbers and types of layers from other embodiments of the described anode assemblies, for the purposes of the present teachings the anode assemblies can be understood to as defining four main, functional regions, including a base or substrate region, a reactive or lithium hosting region, an internal interface region that is defined as being inboard of the lithium hosting region and between the substrate region and the lithium hosting region, and a cover region that is defined as being outboard of the lithium hosting region and being the outermost region of a given anode assembly. As described herein, each of these conceptual regions can include one or more layers and/or films that can provide different functions and that can be formed from appropriate/suitable and compatible materials. For example, the lithium hosting region may include a film of lithium metal, while the cover region may include one film of lithiophilic material and a protective coating to help reduce oxidation. It is also contemplated that in some examples of the anode assemblies that one or more of these regions may be empty, and may not contain any functional films. For example, in some anodes it may be desirable for the interface region to include a bonding film to help facilitate the desired bonding/engagement between the material in the lithium hosting region and the substrate region (e.g. the interface region includes one film), but in other examples the material in the lithium hosting region and material in the substrate region may readily bond to each other in manner such that an intervening bonding film is not required and the interface region need not include any films of material. Such examples can be described has omitting any interface films, or that the interface region contains zero layers of material. Therefore, as described herein it is understood that each function region may include 0, 1, 2, 3 or more separate films.

In some examples, the contents of each region may be determined during the manufacturing process, and may be fixed or generally difficult or impossible to modify once the anode assembly is constructed. Particularly in examples where the various films are applied using a sequential layering processed, such as a multi-stage PVD process, it may be virtually impossible to retroactively add an intervening layer after the assembly has been completed. However, for some layers, such as those in the lithium hosting region, it is possible that portions of the layered anode assembly can be created and then and intervening film can be subsequently introduced into the assembly in a secondary processes, such as a secondary manufacturing step or preferably as a result of having a lithium film created within the anode assembly while it is in situ within a battery or other electrochemical cell, such as by applying a suitable electric potential and charging the battery. Some examples of these different assembly processes are described herein. It is therefore possible, in a given anode assembly, that the lithium hosting region may be empty (or at least free of lithium material) when the assembly is first manufactured, and that lithium is only plated onto the assembly-thereby providing a lithium material film within the lithium hosting region-when the anode is first put into use.

The anode assemblies described herein may be fabricated via a number of processes, including electroplating, electroless plating, lamination, hot-dip metallizing, wave soldering and others, however, for reasons that will be made clear, a roll-to-roll vacuum metallizing (including electron beam or magnetron evaporation), or physical vapor deposition (PVD) process and equipment disclosed herein may offer an advantageous method of manufacturing the anode assembly of the present invention. That is, preferably, the multi-layer anode assemblies described herein can be formed using entirely, or substantially entirely physical vapour deposition processes to form the layers, and more preferably all of the physical vapour deposition processes can be performed on a given substrate during a single pass of the substrate through the PVD apparatus. This may allow a generally raw or bare current collector foil to be fed into the PVD apparatus and a complete, or at least substantially complete anode assembly (allowing for examples where the lithium material is added while the assembly is in situ in a battery or cell and is therefore not added during the single pass PVD process)—and preferably a two-sided anode assembly can be extracted from the PVD apparatus after a single pass.

The specific number of PVD applicators, the type of applicators and the order of the applicators along a given deposition path with a PVD apparatus can be determined by the number and order of the desired films. While any suitable type of physical deposition apparatus can be used, the inventors have determined generally that lithium material can be applied using a thermal evaporation source, polymers can be applied using a thermal evaporation source, chromium (Cr), tungsten (W), titanium (Ti), zirconium (Zr), molybdenum (Mo) and the like may be applied via a magnetron or electron beam applicator (preferably a magnetron), other metals described herein can be applied by via thermal evaporation, a magnetron, or an electron beam applicator (but preferably are applied using a magnetron) and the oxides, hydrides and carbonates and other such materials can be created using a suitable gas source to create an in situ reaction on the surface of the assembly or via a magnetron.

Existing commercial roll-to-roll metallizing equipment typically uses a vacuum chamber into which is loaded a roll of the desired substrate. The chamber is then evacuated to a pressure of 10⁻² to 10⁻⁶ Torr. A resistive, inductive, electron beam, or magnetron source then vaporizes metal as the roll is transferred from the drum onto which it was loaded, onto a receiving drum. When the entire roll has been metallized, the chamber is re-pressurized and the roll removed. A sputtering source may also be used to provide the physical vapor. In a typical cycle, 15-30 minutes are spent loading, 30-60 minutes evacuating, and 60-120 minutes metalizing, 5-10 minutes re-pressurizing and 15-30 minutes unloading, which results in an overall production availability of between 30% & 65%. These numbers are approximations only, and may not be the same for all machines.

Surface contaminants on the substrate to be treated, e.g. from handling material, can result in a relatively poor surface quality and adhesion of the coatings leading to re-work and relatively overall lower production rates and higher production costs. Oxidation and nitridation of lithium-based anodes, such as by atmospheric gases can damage the anode assembly, thereby increasing scrap and reducing productivity, or more generally reducing the performance of battery cells into which the contaminated anode material is incorporated. Additionally, a process which uses lithium foil as an input can be disadvantaged by the relatively high cost of this material.

Therefore, the teachings herein relate to an anode and anode production process that can achieves one or more of the following: avoids use of lithium foil, increases equipment availability and reduces re-work and may help improve the surface quality or surface purity of anode materials.

Another aspect of the teachings herein relates to a method for producing a multi-layer anode or anode assembly by depositing, via a PVD process, successive films of unreactive and reactive metal and or other material (including a solid electrolyte membrane, comprising polymer, glass or ceramic films) onto a substrate, such that the deposition of such films takes place within the same equipment without breaking vacuum, and thereby substantially reducing cycle time. This may help provide one or more of the following advantages over some known systems: the use of lithium foil can be avoided; the opportunities for contamination of substrates are reduced; handling and exposure to the atmosphere is also reduced; the utilization of the equipment can be increased; the energy costs associated with establishing a vacuum can be reduced. This may help provide a lower-cost anode assembly suitable for use in lithium-based batteries.

An apparatus for achieving some of these advantages may include a roll-to-roll vacuum metallizing equipment, having a vacuum metallizing chamber, a vacuum establishing system, two or more sources of vapourized metal, with at least one source for lithium metal, and one for an unreactive metal, a roll magazine (for holding additional feedstock to be coated), an airlock, a roll exchange mechanism, a control system, and optionally, an inert gas containerizing system. Providing multiple sources of vapourized metal within a common vacuum metallizing chamber may help permit two or more different materials to be applied within the chamber without having to re-pressurize and evacuate the vacuum chamber between metal applications. This may save both availability and energy. For example, an apparatus may include two, three, four or more deposition sources within a common environment that can be configured as vacuum environment or a low oxygen and nitrogen environment (for example by applying a vacuum and/or providing an inert gas environment). Advantageously, the incremental cost of additional metalizing or vacuum processing steps is relatively low compared to the cost of the first metalizing step, allowing multi-layered anode-assemblies to be produced without burdening the product with significant additional costs. This is in contrast to rolled foil anode assemblies, which incur the cost of rolling in all cases, and for which the cost of additional process steps is additive.

Optionally, the vacuum metallizing chamber may be accessible via an airlock or other such structure that can allow materials, people and/or equipment to move into and out of the vacuum metallizing chamber without bringing the interior of the vacuum metallizing chamber into direct fluid communication with the surrounding environment. Using a suitable airlock and magazine may help allow one or more additional sets of rolls to be loaded and evacuated while metallization of a roll is in progress. Once metallization is completed, the treated rolls can be replaced with new, untreated rolls without breaking vacuum (e.g. within a single vacuum cycle), thereby increasing availability of the equipment. An inert gas containerizing system can allow finished rolls to be placed and sealed in containers under an inert atmosphere without leaving the equipment, thereby reducing the possibility of contamination of the treated rolls or unwanted reactions between the reactive metal and gases (e.g. oxygen) in the atmosphere. Alternatively, an airlock mechanism need not be included in the system and the vacuum metallizing chamber can be opened to the surrounding environment to load and unload materials, etc. and then closed and a new vacuum can be applied.

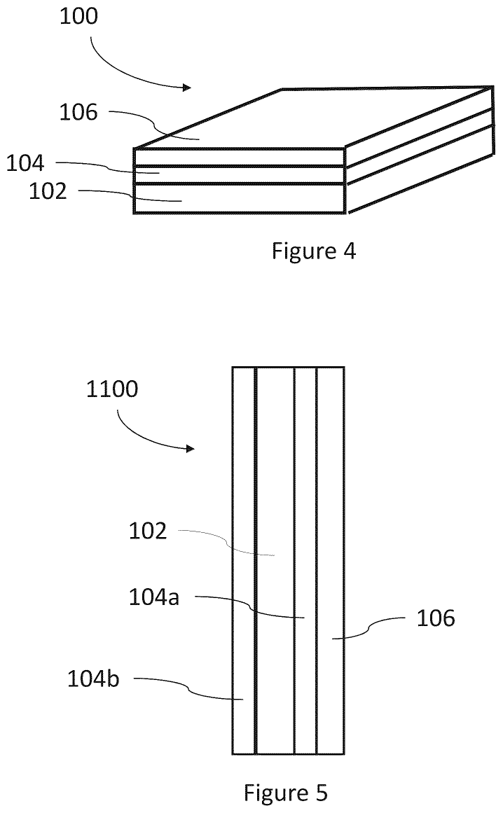

Referring to FIGS. 2-4, one example of an anode assembly 100 includes that includes a current collector 102, a reactive film 106 and a protective film 104 that is positioned between the collector 102 and the reactive film 106 to at least substantially ionically isolate the reactive film 106 from the current collector 102. In this arrangement, the substrate region 190 includes the current collector 102 and the protective film 104, the interface region 194 is empty and does not include any interface films, the lithium hosting region 192 contains the reactive film 106 and the cover region 196 is empty and does not include any films of cover material.

The current collector can be formed from any suitable material, including known metal foils that are suitable for use in batteries as described herein. In the example shown in FIG. 2-4 the current collector 102 is formed from a generally continuous web of aluminum foil. While aluminum is generally consider to be a lithium-incompatible current collector material, the inventors have discovered that unlike previously conceived lithium metal anodes, the inclusion of the protective film 104 can allow the use of an aluminum foil material, which is a lower-cost conductive substrate than copper or other conventional materials, to be used as the current collector 102. This may help reduce the input material cost of the anode assembly 100, relative to assemblies that use other metals or polymers as collector substrates as done in the prior art. Other materials can be used for the collector metal foil if desired in some embodiments, including, copper, aluminium, nickel, stainless steel, steel, magnesium, an electrically conductive polymer, a polymer and combinations thereof. In some of these examples, the current collect may not require the protective film 104, and the substrate region 190 may include only the current collector 102.

Aluminum may be a preferable material for the current collector 102 in some circumstances, as it may have a relatively lower density and relatively higher electrical conductivity as compared to some alternatives, and may be relatively low cost. This can help provide current collectors 102 having a desired size and weight for a given application. However, aluminum may have some drawbacks under certain operating conditions that may make it desirable to use a different current collector material. For example, aluminum may have a relatively lower strength at elevated temperatures (such as those that can be experienced during the PVD process) which may lead to material failure. Also, aluminum tends to react with lithium metal which the inventor has overcome via the use of the protective film 104. A current collector that includes a protective film 104 can be described as a protected current collector or protected substrate, and can optionally be used with a variety of different conductivity films, reactive or performance films and other features of different anode assembly configurations described herein.

The current collector 102, in this example has an inboard or front side 108 that is intended to face the electrolyte and cathode assembly when the anode assembly 100 is in use within a battery and an opposing outboard or rear side 110. The front side 108 can include a coating portion or surface 111 that is the portion of the collector 102 that is bonded to and covered by the protective film 104. The coating surface 111 may cover all, or at least substantially all of the front side 108 as shown in this embodiment, or alternatively may cover less than 100% of the front side 108. In this arrangement, with the coating surface 111 covered by the protective film 104, the support surface 112 of the substrate region 190 is defined by the front face or surface of the protective film 104. In other arrangements, for example in the absence of the protective film 104, the support surface 112 of the substrate region may be provided by the coating surface 111 of the current collector 102.

The current collector 102 may be formed from any suitable metal, and preferably can be formed from aluminum. In the present example, the collector 102 is formed from a continuous web of aluminum foil, but in other examples may have a different configuration. It is the presence of the protective film 104 that can facilitate the use of aluminum foil as the current collector 102 and physical substrate that ultimately supports the lithium metal in the reactive film 106. Preferably, the anode assembly 100 need only include the aluminum foil in the collector 102 as a continuous physical substrate to help support the other portions of the assembly 100, and can be formed without the need to use lithium foil or copper foil (e.g. can be free from lithium foil).

Using aluminum to form the collector 102 may have several beneficial characteristics that make it an excellent current collector. For example, from the available and suitable metals for forming a collector, aluminum may be volumetrically, one of the least costly metals. Aluminum can also be sufficiently strong as a thin foil to resist tearing during the manufacturing of the anode assembly 100 and can be relatively easier to roll, unroll and generally to handle in the manufacturing process as compared to other foils, such as lithium foil. Aluminum is also a sufficiently, and relatively efficient electrical conductor which can help ensure the anode assembly 100 functions as desired.

In fact, these characteristics may be some of the factors that lead to aluminum foil being used frequently in LIBs for the cathode current collector. However, aluminum has generally been considered unsuitable as an anode current collector as contemplated herein (generally because of its incompatibility with lithium metal when directly exposed). For example aluminum can be considered unsuitable for anode current collectors because it alloys readily with lithium under relatively small electropotentials. By displacing aluminum in the crystal structure, the lithium causes the current collector to swell significantly, leading to its degradation and eventual disintegration, thereby limiting the life of the battery. Because of this, aluminum has not used for this purpose in LIBs or for the anode current collector of SSBs to the inventors knowledge.

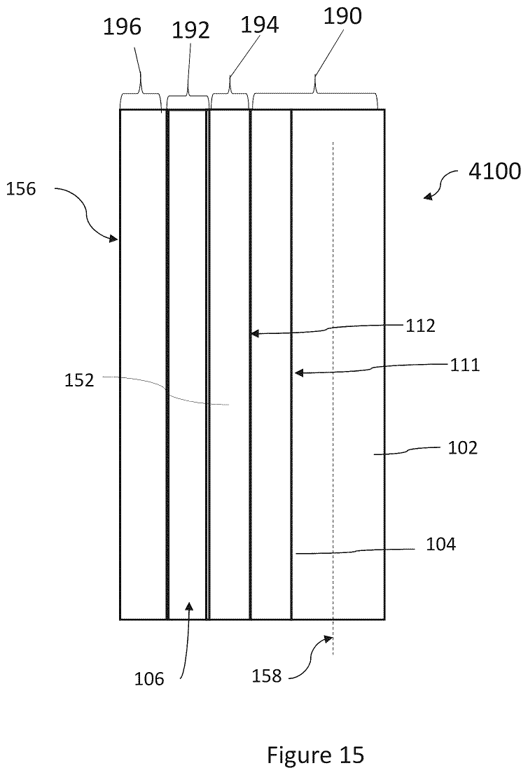

The current collector 102 in this example can be formed having any suitable size, shape and thickness as is suitable for use in a given battery design or similar application. For example, the collector 102 has a collector thickness 114 that can be between about 1 and about 100 microns, or more, depending on a given application-, and may be between about 4 and about 70 microns or between about 10 and 20 microns or between about 5 and 15 microns. However, under some manufacturing conditions, including those that utilize relatively high temperatures (such as temperatures above 150° C.) Aluminum's relatively lower strength may limit the minimum practical thickness 114 of an aluminum collector 102 to between about 10 and about 20 microns while still providing a desired degree of mechanical strength. In embodiments where it is desired that collector 102 has other properties, such as a relatively higher strength, a smaller collector thickness 114 (e.g. is less than 10-20 microns) and the like then other collector materials may be utilized, as described herein (such as with reference to the embodiments shown in FIGS. 14 and 15)

Preferably, the aluminum foil used to form the current collector 102 in this embodiment can be provided as a continuous web of foil that is unwound from a first or source roll of aluminum foil and that can travel through a treatment or fabrication zone during a manufacturing process, in which the materials used to form at least one of (and preferably both of) the protective film 104 and reactive film 106 can be applied to the continuous foil web. In this arrangement, the aluminum collector 102, and the support surface 112 thereon, can physically support the protective film 104 and/or reactive film 106. This may help reduce and/or eliminate the need for the protective film 104 and reactive film 106 to be formed from continuous foils or webs and instead may allow the materials used to form the protective film 104 and the reactive film 106 to be directly deposited or otherwise applied to the support surface 112 of the collector 102. Some examples of a suitable manufacturing process of this nature are described herein.

The protective film 104 is formed from any suitable protective material that can provide a desired degree of electronic conductivity between the reactive film 106 and the collector 102 and that can also (when applied with a suitable thickness) ionically isolate the reactive film 106 from the collector 102. The metal used to form the reactive film 104 is also preferably completely, or at least substantially, inert with respect the both the material of the collector 102 and the material of the reactive film 106 to help prevent galvanic corrosion or other unwanted reactions between the films 102 and 104 or 104 and 106. The particular material used in a given assembly 100 may be influenced by the specific materials used to form the collector and reactive film in that embodiment.

Some examples of suitable materials for forming the protective film 104 are typically metals, and can include copper, nickel, silver, steel, stainless steel, chromium, and other metals into which lithium from the reactive film 106 does not readily intercalate or alloy (e.g. are sufficiently unreactive with lithium metal).

The protective film 104 has a protective or isolation thickness 116 that can be selected to be any thickness that can sufficiently isolate the reactive film 106 from the collector 102, and preferably is selected to be the minimum thickness that provides the desired degree of isolation. For example, thickness 116 may be between 1-75,000 Angstroms, and more preferably maybe between about 1-15000 Angstroms thick, with a thickness of between about 200-7500 Angstroms being most preferred in some embodiments.

The thicknesses 114 and 116 of the collector 102 and protective film 104 can be modified to achieve different battery characteristics and different performance characteristics for the substrate region 190. This may help provide some flexibility for the battery manufacturers to trade-off the capital and inventory costs associated with trickle charging, against the relatively higher anode costs associated with a thicker lithium coating. Such flexibility may allow manufacturers to tailor their production processes to suit the product needs and their business constraints.

Optionally, another metal layer, for example silver, gold, nickel or stainless steel, or any other suitable metal, can be introduced between the protective film 104 and the current collector 102, for example to help improve bonding of the protective film 104 to the aluminum foil in the collector 102 and can be included within the substrate region 190.

The material forming the protective film 104 may be applied to the collector 102 using any suitable technique. One preferred application technique is physical vapour deposition, in which the protective material can be provided as a suitable metal vapour that is deposited onto the support surface 112 as a thin, highly adhered and substantially pure metal (or alloy) coating. The protective film 104 may preferably be formed in one deposition pass/step, or alternatively may be built using two or more passes to build up a protective later 104 having the desired thickness 116. This deposition technique can allow the protective metal material to be bonded to the collector 102 without the need to use a separate bonding material, adhesive or the like.

The reactive film 106, and any other film(s) located within the lithium hosting region 192, can be formed from any desirable, reactive material (including of lithium, potassium, rubidium, cesium, calcium, magnesium and aluminum), and in the examples described herein is formed from lithium metal. The reactive film 106 is sized and shaped to provide the desired contact surface 120 for contacting the electrolyte material in a battery and may have an outer surface 119 that is configured to face and contact the layers in the cover region 196 if present, or the face separator within a battery or electrochemical cell and contact the electrolyte material.

The reactive film 106 can have any suitable thickness 118 (FIG. 3), and preferably may have a thickness that is between about 0.001 and about 100 microns, or may be between about 0.1 microns and about 20 microns.

A reactive film 106 of this nature can be provided using any suitable technique, and preferably can be applied using a deposition technique and without the use of a lithium foil (e.g. is free from lithium foil, while containing lithium metal). In the present example, the reactive film 106 is also applied via physical vapour deposition, in a second deposition process that is performed after the protective film 104 has been deposited. Preferably, both deposition processes can be performed using a common machine, and more preferably are done in the same processing chamber, via a single production pass and under the same vacuum cycle, as described herein. This may help simplify production of the anode assembly and/or reduce the likelihood of portions of the assembly being damaged or fouled between production steps. It may also help reduce the production time for the assembly, as the processing chamber need not be cycled between vacuum and non-vacuum states during the process.

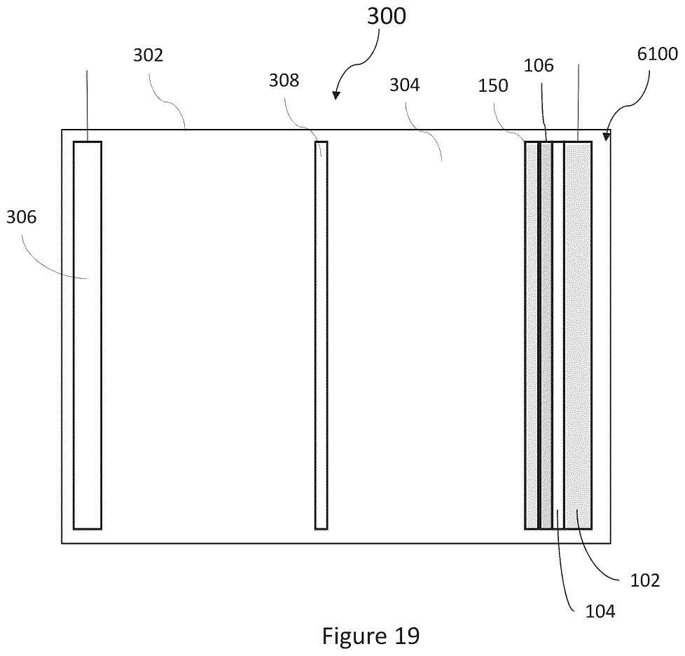

The anode assembly 100 can be further processed or combined with any suitable electrolyte material, including optionally a solid electrolyte, cathode, and other elements to produce a battery cell, such as schematically illustrated electrochemical cell 300 shown in FIG. 19, for use in an electric vehicle or other electronic device. A given battery cell may differ somewhat form what is schematically illustrated while still utilizing one or more aspects of the teachings herein. A given battery may include two or more such battery cells and may have a variety of suitable physical and electrical configurations.

In the embodiment of FIGS. 2 and 3, the protective film 104 is provided on the front surface 108 of the current collector 102. This may be adequate for some intended uses of the anode assembly 100, such as when used in a solid state battery and/or in combination with a solid electrolyte material that is only, or at least substantially only, in physical contact with the reactive film 106. That is, by interposing the film of protective metal between the lithium reactive film and the aluminum collector 102, the aluminum collector 102 can be made substantially inert to the lithium in the reactive film 106 which forms the outer, contact surface of the anode assembly 100. Because solid electrolyte batteries limit the conductive surface exposed to the electrolyte, the aluminum collector 102 would not typically share an ionic connection with the copper protective later 104 and so the assembly 100 is less susceptible to galvanic corrosion.

Alternatively, the collector 102 could be coated with the protective metal material on both sides such that another example of an anode assembly 1100 includes a first, front protective film 104a on the front side 108 of the collector 102 (e.g. between the collector 102 and the reactive film 106) and a second, rear protective film 104b bonded to the opposing rear surface 110 of the collector 102. This may help prevent unwanted chemical reactions, such as galvanic corrosion from affecting at least substantially all of, and optionally all of the front and rear faces of the collector 102.

Optionally, the perimeters of the front protective film 104a and the rear protective films 104b could be joined to each other thereby effectively sealing the collector 102 within the protective material and generally ionically isolating the collector 102 from the surrounding environment. The protective films 104a and 104b can be joined to each other using any suitable technique, including for example, PVD, polymer film or resin application, crimping and the like. Protecting at least the rear surface 108 of the collector 102, and optionally also protecting the side edges of the collector 102 by sealing the front and back films 104a and 104b, may help facilitate the use of the anode assembly 1100 in batteries that use a non-solid electrolyte (e.g. liquid and/or gel, such as conventional LIBs, that may increase the likelihood of the rear surface 108 of the collector 102 being in contact with the electrolyte material.

The rear protective film 104b may be formed using the same process use to form the from protective film 104a (e.g. physical vapour deposition), or via a different process, and more preferably can be formed in a single production pass through the processing chamber.

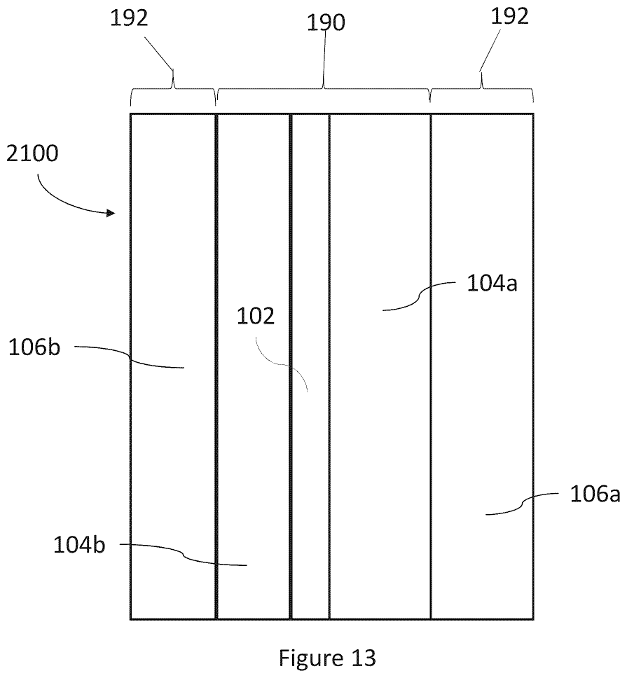

Optionally, some embodiments of the anode assemblies may be configured as double-sided anodes, in which both the front and back sides (or more generally the opposing first and second sides) of the current collector are coated with respective protective and reactive films. One example of double-sided anode assembly 2100 is schematically illustrated in FIG. 13. In this example, the collector 102 has a first protective film 104a on one side with a first reactive film 106a applied to the first protective film 104a. A second protective film 104b is provided on the opposing, rear side of the collector 102 and is covered with a second reactive film 106b. Optionally, as described above the protective films 104a and 104b may be joined together, and in some examples the reactive films 106a and 106b may be joined to each other in an analogous manner. In this arrangement, the substrate region 190 can include the current collector 102 and both protective films 104a and 104b, and separate lithium hosting regions 192 can be provided on each side of the substrate region 190. While not illustrated in this example, separate interface regions 194 and cover regions 196 could also be provided on each side of the assembly 2100.

Referring to FIG. 14 another example of an anode assembly 3100 is illustrated. In this example, the collector 102 is formed from stainless steel rather than aluminum. As such, a protective film (such as film 104) is not needed to protect the current collector 102 from the lithium in the lithium hosting region 192, and the substrate region 190 in this example includes only the current collector 102. As compared to aluminum, stainless steel can have a relatively higher density (approx. 3× aluminum) and a relatively higher mechanical/tensile strength at elevated temperatures, but has a relatively lower electrical conductivity (approx. 1/25 aluminum) which is conventionally recognized as making it a relatively less desirable material to use as a collector 102. However, the inventors have discovered that the relatively higher strength of stainless steel can help facilitate the creation of stainless steel collectors having a thickness that is less than a comparable aluminum collector, and that may have a thickness that is less than about 15 microns, less than about 10 microns and optionally less than or equal to about 5 microns. Such relatively thin, stainless steel collectors may help provide collectors with a similar gravimetric energy density and a relatively higher volumetric energy density than comparable aluminum collectors.

As noted above, one potential disadvantage of using stainless steel is its relatively low electrical conductivity, which can lower the performance of the anode assembly by, for example, increasing the electrical resistance and making deposition of lithium non-uniform on the anode during successive charging cycles. This may be undesirable if the anode assembly is to be used in a solid state battery (SSB), as it may contribute to problems with the contact between the anode assembly and the solid electrolyte material. However, the inventors have discovered that the application of a suitable conductivity enhancing film (e.g. of copper, aluminum, silver, gold or other conductive material) to the stainless steel can increase the assemblies electrical conductivity and make it almost equivalent to aluminum, which can help overcome the apparent disadvantage.

The inventors have also discovered that when using the relatively thin stainless steel collector 102 other apparent limitations of the stainless steel material can be overcome by utilizing alternative anode assembly configurations that can utilize one or more additional functional films, such as a conductivity film, a performance film that can be provided in the interface region 194, and a gas protection film that can be provided in the cover region 196 to help provide an overall anode assembly that has desired physical and electrical parameters.

For example, referring to FIG. 14, in this embodiment the substrate region 190 of the anode assembly 3100 includes a collector 102 that is formed from a relatively thin (e.g. less than about 15 micron) stainless steel foil, and the lithium hosting region 192 includes a reactive film 106 that is formed from lithium (preferably deposited as described herein). As stainless steel does not react with lithium in the same manner as aluminum this embodiment need not include a protective film (such as film 104 above) to help isolate the reactive film 106 from the collector 102. However, alternative films can be provided to help provide the desired levels of conductivity, performance and oxygen/gas protection for the stainless steel collectors 102 and the lithium reactive film 106.

Optionally, the interface region 104 of the anode assembly 3100 may include one or more performance films, such as performance film 150, that is positioned between the reactive film 106 and the collector 102. The performance film 150 is preferably configured to help enhance or positively influence the deposition of the lithium metal (forming the reactive film 106) onto the collector 102 or any intervening film (as described herein), and during successive charging and discharging cycles of the anode assembly when in use, for example by being formed form a material that can help to reduce the tendency of the lithium material to form dendrites when depositing. In this example the performance film 150 is formed from silver, but other comparable materials or combinations of materials may also be used and can help provide the desired deposition enhancement while still providing the desired electrical conductivity and other mechanical properties. For example, the performance film(s) 150 can include lithiophilic materials that are generally compatible with lithium metal and can help provide the enhanced ion mobility within the lithiophilic film layer which can contribute to deposition enhancement effects described herein. In some configurations, the two films of lithiophilic material, such as a lithiophilic interface film 150 and a lithiophilic cover film 150b can be included in a the anode assembly, but can be located indifferent regions, such as the interface region 194 and the cover region 196 as shown. Preferably, the lithiophilic cover film 150b located in the cover region 196 can allow the reactive film material (e.g. lithium) to pass through cover region 196 and be deposited in the lithium hosting region 102 (rather than accumulating in the cover region 196, on the outer surface of the lithiophilic cover film 150b or any other intervening film in the cover region 196), and in fact migrating the reactive material through the lithiophilic cover film 150b may help diffuse the reactive materials entering the lithium hosting region 192 and/or diffuse the reactive materials relative to support surface 112 of the substrate region 190 (whether provided by the current collector 102 or protective film 104) which may help shape/form the reactive film 106 and may help reduce dendrite formation during the reactive material deposition process. While two optional films of lithiophilic material are shown in FIGS. 14 (150 and 150b), if only a single film of lithiophilic material is included it may preferably be located within the cover region 196 (as shown via character 150b in FIG. 14) rather than in the interface region 194.

Optionally, the performance film 150 or 150b may be formed from aluminum, indium, magnesium, zinc, tin, carbon (preferably vapour deposited as black carbon), silver and suitable alloys of combinations thereof. Further a given performance film 150 in a given anode may include a single film of a single material, two films of different materials, or films formed from an alloy or mixture of two or more materials all of which may be understood to be a performance film as described herein.

While the performance film 150 is shown in one location in this example, performance films may can also and/or alternatively introduced between the reactive film 106 and the coated collector 102, between successive films of lithium material within the reactive film 106 (or between successive reactive films 106), co-deposited with the lithium in the reactive film 106 (i.e. substantially as an alloy reactive film), and/or on the outer surface of the lithium reactive film 106 (as shown via optional film 150b), all via PVD. More than one performance film may be provided on a given side of the collector 102 (i.e. both films 150 and 150b may be included in some examples).

Films 150 of this nature may act as a protective film that can help reduce unwanted reactions between the lithium films, if any, and the electrolyte within a given battery cell (which may be a solid or liquid electrolyte). These films may also help protect the reactive, lithium film from exposure to air or the ambient atmosphere during the manufacturing and/or assembly processes.

Optionally, the assembly 3100 may also include one or more conductivity films in the interface region 194 (in addition to the lithiophilic performance film 150), such as a conductivity film 152, that can be positioned between the reactive film 106 and the collector 102, and preferably between the performance film 150 (if any) and the collector 102. The conductivity film 152 is preferably formed from a material that has a higher electrical conductivity than the material forming the collector 102 (e.g. stainless steel in this example), to help improve the performance of the anode assembly 3100. Suitable materials for the conductivity film can include copper, aluminum, silver, gold or other such materials, and combinations or alloys thereof. The addition of the conductivity film 152 can help enhance the electrical conductivity of a stainless steel collector 102 to a level that is approximately within the same order of magnitudes as the aluminum collectors described in other embodiments herein. The conductivity film 152 may have any suitable thickness, and may be between 0.1 and 5 microns thick.

In some environments the lithium in the reactive film 106 may react with the surrounding environment, which may impact the performance and/or life of the assembly 3100. For example, the reactive film 106 may tend to react with oxygen, nitrogen and/or water vapour present in the air if it is exposed to the air or ambient environment. Such exposure may degrade the reactive film 106. To help limit such reaction and/or degradation, the cover region 196 of assembly 3100 may include one or more suitable gas protection films, such as passivation film 156, that can be deposited over the reactive film 106 and any other films within the lithium hosting region (for example via PVD). Preferably, the material(s) used in the passivation film 156 are less reactive with the environment than the reactive film 106 but still possess desirable electrical conductivity and mechanical properties, and notable can allow a sufficient lithium ion flux to allow the lithium ions to move between the electrolyte and the lithium hosting region when the anode assembly is in use. Some examples of suitable materials that can be used in the passivation or gas protection film 156 can include metallic materials such as gold, platinum or other precious/inert metals, and/or may include oxide materials such as aluminum oxide, lithium oxide, lithium aluminate, mixed metal oxides (preferably containing at least some lithium), or any gas-blocking material that can be deposited by PVD. Depositing a layer of a suitable metallic or oxide material can help reduce the amount of gas diffusion into the coated surfaces of the anode assembly 3100 while still allowing/facilitating the desired lithium transport. Preferably, the thickness of the gas protection film can be selected so that, for a given embodiment, it is thick enough to inhibit gas diffusion into the lithium hosting region 192 but thin enough so as to not materially impede the rate of lithium metal oxidation. In some examples, the thickness of the gas protection film may be 0.01 to 5 microns thick. If an anode assembly includes this optional gas protection film 156 it is preferably the outermost film in the cover region 192.

While assembly 3100 is shown as a single-sided, assembly (e.g. with functional layers provided only on one side of the collector 102) it can optionally be configured as a two-sided assembly by providing the same, or analogous but not identical groups of function layers on the opposing side of the collector 102 (i.e. on the opposite side of the centreline 158 shown in FIG. 14).

Referring to FIG. 15, another example of an anode assembly 4100 is configured to utilize an aluminum collector 102 and includes a protective film 104 (as described herein) positioned between the collector 102 and the reactive film 106. This example omits the conductivity film 152 of FIG. 14 (which is not required when using an aluminum collector 102) but includes a performance film 150 and gas protection film 156, in their respective regions 194 and 196, as described with reference to FIG. 14.

In addition to helping to protect the completed anode assemblies, the gas protection film 156 may be useful to help protect the reactive film 106 and/or other components during the assembly process, particularly if the assembly is to be conducted in an environment that includes oxygen, nitrogen, moisture and the like. For example, the gas protection film 156 may be applied shortly after the reactive film 106 is applied to help limit the exposure of the reactive film 106 to the ambient environment during handling or production. This may allow the anode assemblies to be produced in a wider range of ambient environments. An anode assembly that includes a protected current collector may still benefit from ability to use the relatively lighter and/or lower cost substrate materials, while limiting their reactivity with other battery components, even if the anode does not itself include lithium metal.

in accordance with one embodiment described herein, another example of an anode assembly for use in a battery, including a lithium-based battery or optionally an alkaline battery or other battery type, can include a protected current collector having a substrate that is formed from a suitable collector material and that has a support surface that is intended to receive/support other components of the assembly. The collector material may be any of the suitable materials described herein, such as aluminum, copper, aluminium, nickel, stainless steel, steel, magnesium, zinc, silver, an electrically conductive polymer, a polymer and combinations or alloys thereof, and lithium-alloys of such materials including, for example, lithium-silver alloys, lithium-magnesium alloys, lithium-zinc alloys) and the like. For the purposes of discussion the collector material in this example will be referred to as aluminum, but can be other suitable materials in other examples.

To help reduce the chances of an unwanted reaction between potentially reactive materials within the anode assembly or other parts of the battery cell that the aluminum in the protected current collector is covered with a suitable protective film that is bonded to and covers at least the support surface, and includes a protective metal that is suitably electrically conductive as described herein. In this arrangement the protective film is preferably disposed between the current collector substrate the potentially reactive materials within the battery cell so that electrons can travel within the cell as desired and the current collector substrate is at least substantially ionically isolated from the reactive materials. The protective film can therefore help at least substantially prevent or inhibit, and may completely prevent diffusion of the reactive materials within the battery cell to the current collector which can help at least substantially inhibit, and optionally completely prevent unwanted reactions between the lithium metal and the current collector. This type of isolation between the current collector substrate and the reactive film may help facilitate the use of lithium in the reactive film while helping to facilitate the use of a material in the current collector that may be generally desirable to use as a current collector but that would otherwise (e.g. in the absence of a suitable protective film) react with the lithium or other such materials within the battery cell in a manner that reduces the effectiveness of the current collector, anode assembly and/or that may damage or reduce the usefulness of the anode assembly or its sub-layers.

For example, referring again to the schematic representation of the anode assembly 4100 in FIG. 15, another example of an anode assembly can include an example of a protected current collector, that includes an aluminum collector 102 and a protective film 104 that covers at least a portion of the surface of the collector substrate 102. Other materials could be used for the reactive film 106 in other examples.

This version/example of the anode assembly 4100 can be assembled using the techniques described herein, and the protective film 104 can be deposited on the collector substrate 102 via PVD to provide the protected current collector sub-assembly.

In some examples, the reactive film 106 may not include lithium when first deposited, however when the anode assembly 4100 is in use within a battery cell lithium ions may accumulate within the material of the reactive film 106 or plate directly onto the protective film 10 (such as during charging) and would tend to react with the aluminum material in the current collector 102 if not for the presence of the intervening protective film 104.

In further examples of the anode assembly 4100 the protected current collector can include a performance film 156 deposited directly onto the surface of the protective film 104. When properly selected, the materials in performance film 156 can permit the deposition of lithium through the performance film 156 directly onto the protective film herein, thereby allowing the active film to form between the performance film 156 and the protection film 104 in situ after the cell has been assembled. The material or combination of materials in the performance film 156 can be selected to also improve the plating/stripping behaviour of the final anode assembly and increasing cycle life by, for example, reducing the tendency to form dendrites, preventing undesirable reactions with the electrolyte material, improving the mechanical properties of the active film, increasing the chemical and mechanical compatibility between different layers in the anode structure or between the anode interface and the electrolyte. Suitable materials for the performance film 156 include the metals aluminum, arsenic, bismuth, indium, lead, magnesium, tin, zinc, and combinations thereof, and lithium-ion conducting oxides such as lithium-ion conducting oxides, nitrides, sulphides and fluorides, such as lithium nitride, LiPON, lithium argyrodites, and lithium-ion conducting polymers, such as polyethylene oxide, or combination so of any of the above.

Referring to FIG. 19, one exemplary electrochemical/battery cell 300 that can utilize the anodes described herein, can also include a housing 302, containing any suitable electrolyte materials 304, a suitable cathode 306 and a suitable separator 308 disposed therebetween.

In this embodiment, another example of an anode 6100 can optionally be configured to utilize an aluminum collector 102 and includes a protective film 104 (as described herein) positioned between the collector 102 and the reactive film 106 that can help isolate the collector 102 from the lithium in the reactive film 106. The anode 6100 also includes a performance film 150 that covers and separates the reactive film 106 from the electrolyte materials 304 within the cell 300. Some or all of the films 104, 106 and 150 can be applied by PVD as described herein. In this arrangement, the anode 6100 can optionally be provided with its reactive lithium film

Alternatively, the anode used within a cell, like cell 300 can be initially formed without including a lithium reactive film or may include a partial lithium reactive film that contains less lithium than would be present if the cell 300 were charged. That is, when first produced the anodes may include a substantially complete lithium reactive film, a partial lithium reactive film or need not include lithium metal reactive film when manufactured.

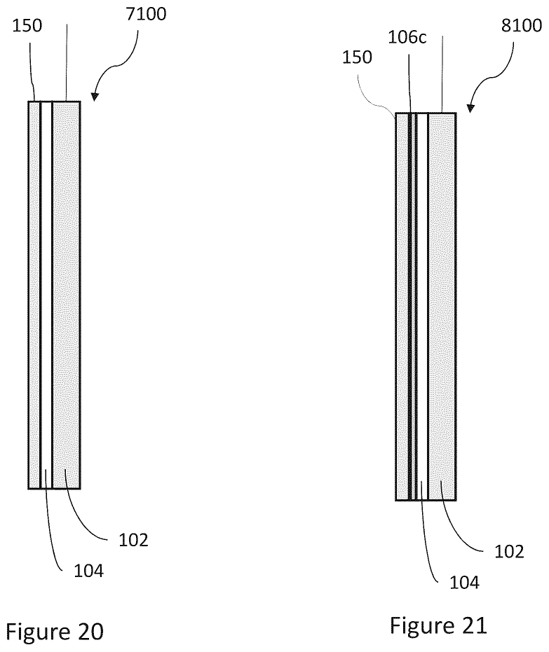

For example, one method of forming an anode for use with lithium-based cell can include the steps of providing a suitable collector 102, depositing a protective film 104 onto at least a portion of the collector 102 (preferably via PVD), and depositing a performance film 150 over at least a portion of the protective film 104 (preferably via PVD). This can provide a lithium-free, multi-film anode such as the schematically illustrate anode 7100 in FIG. 20. Optionally, such a lithium-free, multi-film anode 7100 may be disposed within a suitable cell, such as cell 300, and lithium may be added to the anode 7100, to provide the desired reactive film 106, while the anode 7100 it is in situ within the cell 300 by charging the cell (e.g. applying a potential between the anode and cathode).

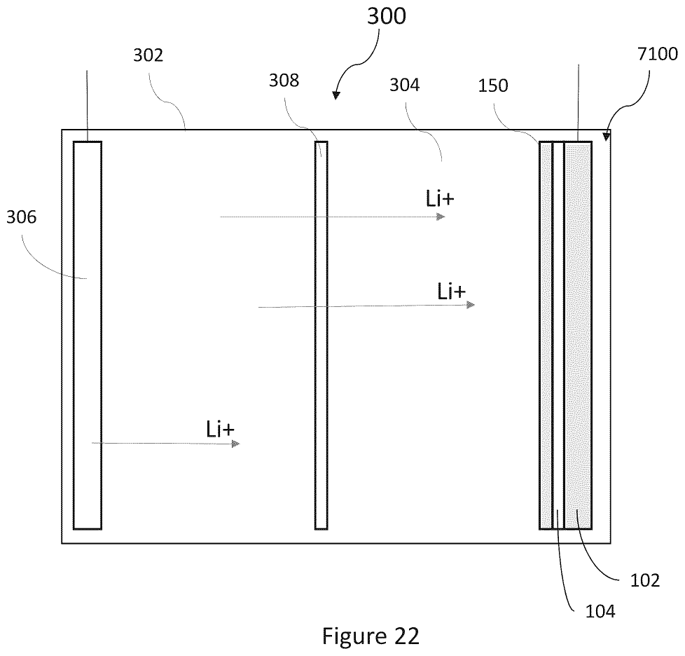

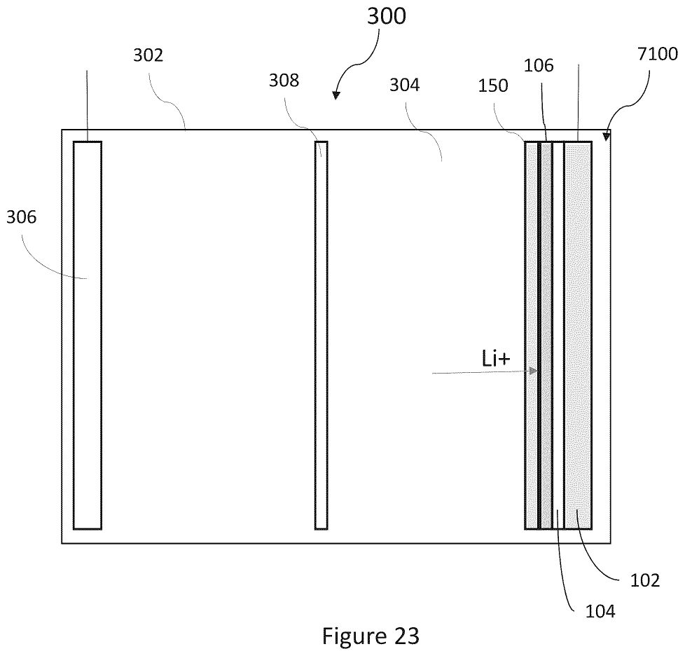

For example, referring to FIG. 22, the anode 7100 may be provided within the cell 300 and the cell 300 can be charged. Referring also to FIG. 23, during this charging operation, lithium ions may migrate toward the anode 7100 (and may generally be transferred from the cathode 306 to the anode 7100) and may be collected/accumulate on the anode 7100 to form a suitable reactive film 106. In examples where the performance film 150 is formed from a suitably lithiophilic material the lithium ions that are driven in this manner can migrate through, and/or alloy with the performance film 150 and may form the lithium reactive film 106 on the face of the protective film 104 (e.g. plate underneath the performance film 150). Having the lithium ions migrate through at least a portion of the performance film 150 may help distribute the lithium metal across the face of the protective film 104 and may help reduce dendrite formation as the lithium metal is deposited.

Alternatively, an anode may be manufactured to include a partial reactive film during the assembly process (e.g. a layer with some lithium but less than the expected operating amount of lithium) and then some additional lithium metal may be added to the partial reactive layer in situ within the cell. For example, an anode 8100 as shown in FIG. 21 for use with lithium-based cell 300 can be formed using a process that include the steps of providing a suitable collector 102, depositing a protective film 104 onto at least a portion of the collector 102 (preferably via PVD), depositing a performance film 150 over at least a portion of the protective film 104 (preferably via PVD) and depositing lithium metal to form a partial reactive film 106c that contains some lithium metal but has less lithium metal than is would be present in the anode when the anode is charged when in use within a battery cell. The anode 8100 can then be positioned within the cell 300 (in an analogous manner to the anode 7100 shown in FIG. 22) and the cell 300 can be charged. During the charging operation, additional lithium metal can migrate from the cathode, can pass through the performance film 150 and can add to the partial reactive film 106c, thereby providing a complete reactive later 106 that has a desired size/thickness. In this arrangement, the reactive film 106 is partially formed during the anode assembly process (e.g. to provide the partial film 106c) and is then completed during the in situ charging process.

The deposition of the lithium metal in the reactive film 106c in this example may be done prior to forming the performance film 150 or optionally may be done after depositing the performance films 150 as the lithium metal may alloy with or migrate through the performance film 150 to form the desired, partial reactive film 106c. That is, the reactive film 106 or partial reactive film 106c may be deposited before the performance film 150 or may be deposited after the performance film 150. The partial reactive films 106c formed in this manner may include less than 90%, 80%, 70%, 60%, 50%, 40%, 30%, 20% or less than 10% of the amount of lithium metal that may be present in the reactive film 106 when the cell 300 is charged. That is, a given anode may include between about 0% and 100% of the lithium metal that is contained in the charged reactive film 106 when first formed.

Forming anodes, such as 7100 and 8100 that include less lithium metal, and optionally are substantially free of lithium metal (e.g. have no reactive film 106 or only a partial reactive film 106c) may help simplify the manufacturing and/or assembly process as the anodes may contain less reactive lithium metal. This may help reduce reactivity of the anodes, it may help reduce the need to utilize modified atmosphere and/or low oxygen manufacturing environments and/or may help make the anodes relatively more stable for storage and transport than analogous anodes manufactured to contain the full charge reactive film 106.

For exemplary purposes only, some comparative cost estimates are included below in Tables 1-7 with some estimates of the costs of the input materials used to make some conventional anode assemblies and an estimate of the costs of the input materials used in the anode assemblies described herein.

TABLE 1
Conventional Lithium Foil Anode Est. Cost (2019)

| | Material/ | Thickness | Unit Cost |
|---|---|---|---|
| | Method | (microns) | (USD/m²) |
| Current Collector | Li Foil | 12.5 | 6.675 |
| Active Anode | Li Foil | 20 | 10.68 |
| Processing | Single Piece | | 0 |
| Total Cost | | | 17.4 |

TABLE 2
Conventional Cu Foil and Li Foil
Anode Assembly Est. Cost (2019)

| | Material/ | Thickness | Unit Cost |
|---|---|---|---|
| | Method | (microns) | (USD/m²) |
| Current Collector | Cu Foil | 12.5 | 1.12 |
| Active Anode | Li Foil | 20 | 10.68 |
| Processing | Lamination | | 0.050 |
| Total Cost | | | 11.85 |

TABLE 3
Lithium Metal Anode Assembly Est. Cost (2019)

| | Material/ | Thickness | Unit Cost |
|---|---|---|---|
| | Method | (microns) | (USD/m²) |
| Current Collector | Cu Foil | 12.5 | 1.12 |
| Protective Film | None | 0 | 0.00 |
| Active Anode | PVD Li | 20 | 1.63 |
| Processing | PVD | | 0.73 |
| Total Cost | | | 3.48 |

TABLE 4
Low-Cost Lithium Metal Anode Assembly According
to Present Disclosure Est. Cost (2019)

| | Material/ | Thickness | Unit Cost |
|---|---|---|---|
| | Method | (microns) | (USD/m²) |
| Current Collector | Al Foil | 12.5 | 0.17 |
| Protective Film | Cu | 0.015 | 0.001 |
| Reactive Film | PVD Li | 20 | 1.63 |
| Processing | PVD | | 0.40 |
| Total Cost | | | 2.21 |

TABLE 5
Thin Lithium Metal Anode Assembly (For
Trickle-Charging) Est. Cost (2019)

| | Material/ | Thickness | Unit Cost |
|---|---|---|---|
| | Method | (microns) | (USD/m²) |
| Current Collector | Cu Foil | 12.5 | 1.12 |
| Protective Film | None | 0 | 0.00 |
| Active Anode | PVD Li | 0.1 | 0.01 |
| Processing | PVD | | 0.00 |
| Total Cost | | | 1.13 |

TABLE 6
Thin Low-Cost Lithium Metal Anode Assembly According to Present
Disclosure (For Trickle Charging) Est. Cost (2019)

| | Material/ | Thickness | Unit Cost |
|---|---|---|---|
| | Method | (microns) | (USD/m²) |
| Current Collector | Al Foil | 12.5 | 0.17 |
| Protective Film | Cu | 0.015 | 0.001 |
| Reactive Film | PVD Li | 0.1 | 0.01 |
| Processing | PVD | | 0.003 |
| Total Cost | | | 0.18 |

TABLE 7
Approximate Costs for Current Collector Substrate Materials (Est. 2019)

| | | | | | Stainless | PVDF | | |
|---|---|---|---|---|---|---|---|---|
| | Aluminum | Nickel | Copper | Lithium | Steel | (resin) | Silver | Gold |
| Density (kg/m3) | 2700 | 8900 | 8960 | 534 | 8000 | 1780 | 10500 | 19320 |
| Material Cost (USD/kg) | 1.875 | 13.165 | 6.5 | 150 | 3.3 | 8 | 487 | 43408 |
| Substrate Raw Material Cost | 0.05 | 1.17 | 0.58 | 0.80 | 0.27 | 0.14 | 51 | 8386 |
| (USD/m² @ 10 microns thick) | | | | | | | | |

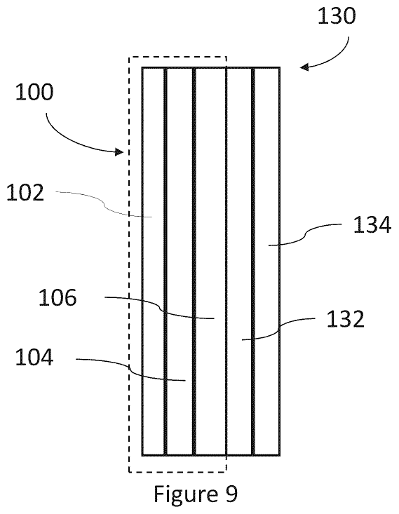

The anode assemblies 100 and 1100 can be used in combination with other components to provide a lithium-based battery that includes any suitable cathode assembly comprising a cathode current collector and a cathode reactive surface along with a lithium anode assembly as described herein. An electrolyte can be disposed between and can contact the cathode reactive surface and the anode reactive film, and the first protective film can be disposed between the support surface and the reactive film so that electrons can travel through the first reactive film and first protective film from the electrolyte to the anode current collector. The first reactive film can be spaced from and at least substantially ionically isolated from the support surface whereby diffusion of the reactive film to the current collector is substantially prevented by the first protective film thereby inhibiting reactions between the lithium metal and the current collector. That is, the first protective film can at least substantially ionically isolate the support surface from the electrolyte. One schematic example of a battery 130 is shown in FIG. 9, and includes the anode assembly 100 in combination with a schematic representation of an electrolyte 132 and suitable cathode assembly 134.

Depending on the battery design the electrolyte may include a solid electrolyte material that directly contacts that first reactive film and does not directly contact the anode current collector, or may include a different type of electrolyte material. Preferably, the anode collector (e.g. collector 102) is encased by the protective metal in the protective film(s) 104 and is physically and ionically isolated from the electrolyte.

The anode assemblies described herein may be manufactured using any suitable manufacturing process, including those described herein. Preferably, the manufacturing process can utilize at least two physical vapour deposition processes to apply the protective and reactive films 104 and 106 onto the collector 102, and more preferably can be conducted in at least a semi-continuous process in which the payers 104 and 106 are depositing on a moving aluminum foil web in a roll-to-roll process. As physical vapour deposition is to be conducted at low pressure/vacuum conditions, the manufacturing process can preferably be configured so that both the protective and reactive films 104 and 106 are deposited onto the collector 102 within a common processing/metalizing chamber and while under the same vacuum cycle and conditions. This may help reduce or eliminate the need to break the vacuum conditions between depositing the protective film 104 and the reactive film 106, which can help shorten the manufacturing time and/or reduce the amount of energy required to re-create a second vacuum condition when depositing the reactive film 106. Optionally, the completed material (e.g. the collector 102 with protective and reactive films 104 and 106) can be wound onto an output roll at the end of the roll-to-roll process and preferably the output roll can then be packaged and/or otherwise treated while still within the same vacuum chamber to that the packaging and/or treatment can be completed before the output roll is exposed to oxygen in the ambient environment.

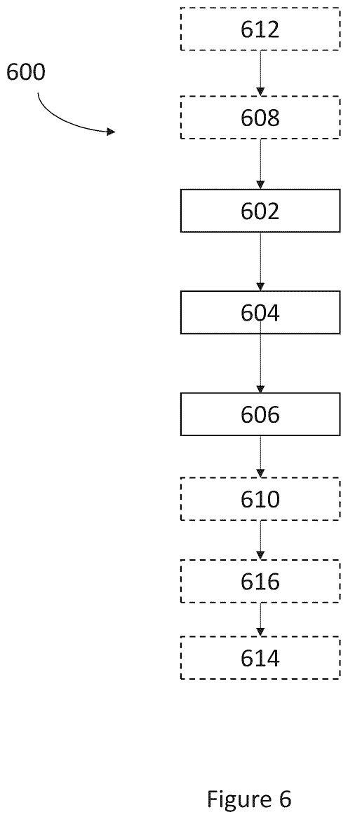

Referring to FIG. 6, one example of a method of manufacturing an anode assembly 600 includes, at step 602 providing a metallic, current collector substrate (e.g. collector 102) within the interior of a metalizing or processing chamber that can be configured at atmospheric pressure and can selectively be configured (such as by using a suitable vacuum pump apparatus or the like) to have an interior operating pressure that is less than atmospheric pressure. The operating pressure in the metallizing chamber can be any suitable pressure that facilitates the desired physical vapour deposition process, and can be between about 10⁻² and 10⁻⁶ Torr in some examples. Preferably, this can help provide an interior the processing chamber that is substantially free of oxygen while the films 104 and 106 are formed.

At step 604, the support surface 112 on the collector 102 is at least partially coated with the protective metal material via a first physical metal deposition process, using one or two or more passes, to build up and provide the protective film 104.

At step 606 the protective film 104 is at least partially coated with the reactive metal material via a second physical metal deposition process, using one or two or more passes, to build up and provide the reactive film 104, whereby the first protective film 104 is disposed between the support surface 112 and the reactive film 106 so that electrons can travel from the first reactive film 106 to the current collector 102 and the first reactive film 106 is spaced from and at least substantially ionically isolated from the support surface 112, and whereby diffusion of the reactive film 106 to the support surface 112 is prevented by the first protective film thereby inhibiting reactions between the reactive metal and the current collector 102.

Preferably, the collector 102 material is a continuous, metallic foil that is unwound from a first input or feed roll prior to step 602, via optional step 608, and then wound onto a first output roll after step 606, via optional step 610. In this arrangement, steps 604 and 606 can preferably be carried out while the continuous, metallic foil web is moving between the first feed roll and the first output roll along the deposition path.

The first, and subsequent feed rolls can be supported by any suitable unwinding apparatus that preferably is also located within the low pressure processing chamber so that the roll can be unwound and the web accessed while maintaining the vacuum in the chamber. Similarly, the output roll can be held on a suitable winding apparatus that preferably is also located within the low pressure processing chamber so that the output roll can be wound while maintaining the vacuum in the camber. The web may move between the input and output rolls at any suitable processing speed that allows the desired deposition processes to be successfully completed, and may be between about 1 or 2m/min and about 1500m/min, and optionally may be between about 1m/min and about 20m/min, or between about 2m/min and about 10m/min in some preferred examples.

Optionally, step 604 can include providing the protective metal from at least one protective metal vapour source apparatus, such as a protective metal vapour source that is configured to deposit between about 0.001 and about 10 microns of the protective metal on the support surface 112 in a single pass while the web is moving at the processing speed. This deposition process may then be repeated if needed, for example by reversing the travel of the web and then passing the previously coated portions of the support surface 112 past the protective metal vapour source for a second and/or subsequent pass and depositing the protective metal onto the support surface 112 until the first protective film has as thickness of between about 1 and about 75,000 Angstroms. Alternatively, as described herein, these steps may be completed in a single pass using a suitable deposition apparatus with an appropriate number and arrangement of deposition zones.

Optionally, step 606 can include providing the reactive metal from at least one reactive metal vapour source apparatus, such as a reactive metal vapour source that is configured to deposit between about 0.001 and about 20 microns of the reactive metal on protective film 104 in a single pass while the web is moving at the processing speed. This deposition process may then be repeated if needed, for example by reversing the travel of the web and then passing the previously coated portions of the protective film 104 past the reactive metal vapour source for a second and/or subsequent pass and depositing the reactive metal onto the protective film 104 until the first reactive film has as thickness of between about 1 and about 40 microns. Preferably reactive metal vapour source can be spaced apart from, and optionally can be downstream from the protective metal vapour source in the direction of web travel. This may allow both the protective film 104 and reactive film 106 to be formed in a single pass of the collector web, provided that reactive metal vapour source and protective metal vapour source are operated to deposit a sufficient amount of their respective metals in a single pass.

Optionally, prior to beginning to unwind the collector web and begin the deposition processes the method 600 can include, at step 612, reducing the pressure in the interior of the processing chamber from generally atmospheric pressure to the operating pressure and then introducing the first feed roll into the interior of the processing chamber via an airlock whereby the first feed roll can be conveyed from outside the processing chamber to inside the processing chamber without increasing a pressure in the interior of the processing chamber above 1 kPa.

Preferably, the pressure in the airlock can be reduced to a suitable transfer pressure that is less than about 10⁻² torr and preferably substantially matches the operating pressure prior to opening the chamber door to join the chambers, but in some examples the transfer pressure in the air lock may less than atmospheric pressure but may still be higher than the operating pressure. This may help allow the metallizing chamber to be maintained at, or at least substantially close to the operating pressure while new rolls of collector foil are brought into the chamber without breaking the vacuum—e.g. during the same vacuum cycle. A vacuum cycle can be understood to include a substantial depressurization of the metallizing chamber (such as from about atmospheric pressure to close to or to the operating pressure), an operating period at which the chamber is held at substantially the operating pressure and the metal deposition can take place, and then a subsequent re-pressurization of the metallizing chamber to a pressure that is substantially greater than the operating pressure and under which the deposition processes may not function as intended (such as returning from the operating pressure to about atmospheric pressure, or other increases of about 50 kPa or more). Minor difference in the air-lock pressure or transfer and metallizing chamber pressures during the transfer of rolls of foil may require a small correction to the metallizing chamber pressure when the transfer is complete, but such pressure differences will preferably be less than about 10⁻² torr, and preferably less than about 10⁻⁶ torr or less and can be considered to be within the same vacuum cycle for the purposes of the teachings herein. Because pressurizing and depressurizing the metallizing chamber may take time and require additional energy inputs to drive a suitable vacuum apparatus, incorporating an air-lock as described herein can reduce the amount of time it takes to introduce a new foil roll into the processing chamber because it is not necessary to break vacuum and then restore the vacuum conditions within the processing chamber (e.g. it can allow two or more rolls of foil to be treated by the physical vapour deposition apparatus within a single vacuum cycle of the metallizing chamber).

Similarly, the method 600 can include the optional step 614 in which the first output roll (holding the completed assembly materials) can be removed from the interior of the processing chamber via an airlock (optionally the same airlock or a different airlock that was used to introduce the feed roll) whereby the first output roll can be conveyed from inside the processing chamber to outside the metalizing without increasing a pressure within the interior of the processing chamber above about 10⁻² torr.

The method can also include an optional packaging step 616 during which first output roll can be packaged, treated and/or sealed while still contained within the air tight, low pressure interior of the processing chamber, or of the airlock, or within an air tight interior of a separate receiving chamber having an interior that is substantially free of oxygen prior to removing the first output roll from the airlock. This can help reduce the chances of the finished anode assemblies being exposed to oxygen.

It will be appreciated by those skilled in the art that the processes described herein have not described every single optional operation or equipment that may be performed or used when treating/coating the rolls, such as certain surface preparation steps, such as plasma cleaning, flame treatment, corona discharge, or tacky roller contact, or instrumentation, such as pressure sensors, tension sensors, and gas analyzers, or miscellaneous equipment, such as cooled deposition drums, idler rollers, and rewinding rolls, that are commonly used in vacuum metallizing systems. Such processes and equipment have been omitted for clarity, and are considered to be incorporated as needed herein.

Optionally, the methods described herein may also be supplemented to include additional vapour deposition sources, or other deposition sources suitable for applying a film to the roll. Such processes could, for example apply additional bonding layers, or solid electrolyte layers, cathode layers and cathode collector layers onto the coated aluminum foil webs while still being operated within the same metallizing chamber and without having to re-pressurize the chamber between sequential operations/coatings.

The methods described herein can be modified and applied to other suitable reactive metal metallizing process of substrates such as copper, nickel, stainless steel, magnesium, conductive polymers, or non-conductive polymers.

The methods described herein can be applied to other suitable reactive metal metallizing process, where layered structures are produced for applications and need not be limited only to the production of anode assemblies.

The anode assemblies and methods described herein can be produced using any suitable apparatus that can include a variety of different components and sub-systems as appropriate.

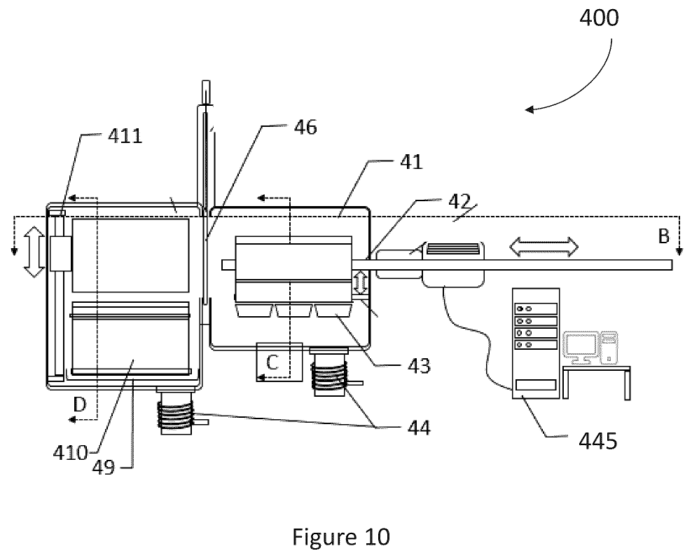

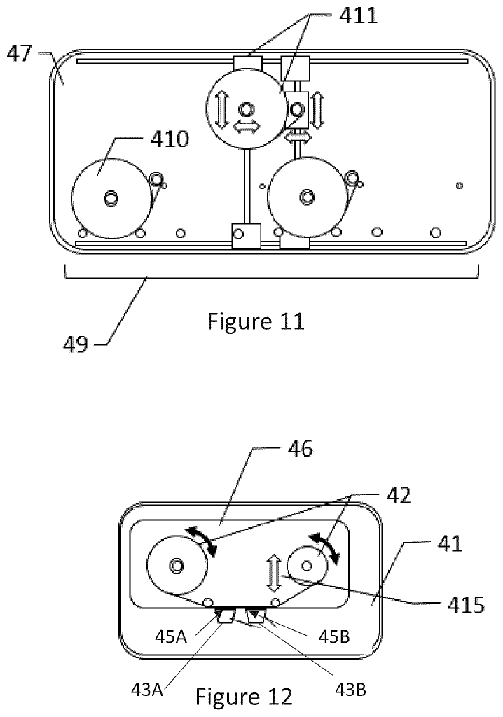

One example of apparatus that can be used to produce the anode assemblies described herein is described below and is schematically illustrated in FIGS. 10-12. These schematic illustrations show how aspects of the apparatus can be arranged to work together, but for clarity do not include illustrations of every piece of hardware, etc. that would be included in a production version of the apparatus.

In this example, a roll-to-roll metallizing apparatus 400 includes a metallizing or processing chamber 41 having an interior that is configurable at an operating pressure that is less than about 0.001 kPa during a first vacuum cycle. A roll-to-roll winding assembly is located within the metallizing chamber and in this example includes first and second reversible driven roll spindles 42. A vacuum pumping system 44 that is preferably capable of achieving the desired operating pressures 10⁻²-10⁻⁶ Torr of vacuum is connected to the metallizing chamber and can be controlled by any suitable controller 445, which in this example includes a computer control system 445 (but could include other controllers, such as PLCs and the like and may also include any desired sensors, transducers and user input/output devices). The controller 445 can be configured to control typical parameters such as roll speed, source intensity, vacuum, roll direction, etc. Unlike conventional control systems, the controller may also control the air-lock cycles through position encoders, vacuum gauges, etc., and the roll exchange cycle processes.

The chamber 41 is bounded by chamber walls and includes at least one openable chamber door, shown as door 46, through which feed rolls of foil/substrate 410 can be introduced into the metallizing chamber 41. The vacuum metallizing chamber 41, vacuum pumping system 44 and reversible roll spindles 42 used to hold the feed and/or output rolls during manufacturing are shown schematically for reference and can be of any suitable design for a given example of this apparatus 400.

The apparatus 400 can also optionally be equipped with tensioners, idling rollers, typical sensors and/or suitable pre-treatment equipment (roll cleaning, plasma cleaning, corona treatment, etc.), as desired, which equipment can be incorporated as appropriate but is not shown in the current figures for clarity.

In this example the treated rolls of foil are also removed via the same door 46, such as by handling apparatus 411 to be held in a storage region 49, but in other examples the chamber 41 may have two or more separately located and openable chamber doors.

The physical vapour deposition equipment is also positioned at least partially within the metallizing chamber 41 and is configured to, during the first vacuum cycle, treat the roll of foil within the chamber 41 by independently depositing i) a layer of a protective metal onto a first foil web travelling between the first and second spindles 42 and ii) a layer of a reactive material onto the layer of protective material. In the illustrated example, the physical vapour deposition apparatus includes metal vapour sources 43, including protective applicator 43A (FIG. 12) that can apply the protective material and a reactive applicator 43B that can apply the reactive material. These applicators 43A and 43B are spaced apart from each other along a deposition path 58 in the processing direction(s) that the web of foil 60 will travel within the processing chamber 41 when moving between the rolls of material that are held on spindles 42 (as described herein), thereby also defining respective deposition regions 45A and 45B on the deposition path.

In this example the deposition path 58 is understood to be defined by the path that the substrate web 60 follows within the processing chamber 41 where the deposition steps will occur. This path need not be linear, and instead can be serpentine and may include a variety of changes of orientation of the substrate web 60, while the substrate web 60 can still be understood as either moving in a first or opposing second direction (such as a forward and backward direction) between the rolls of material located at the first and second ends of the deposition path. In this example, the spindles 42 are reversible and the web 60 can move in two directions along the deposition path, and may be moved through the processing chamber, and past a given deposition region 45A and 45B, more than once. In other arrangements, the deposition apparatus and deposition path may be configured in a one-direction or single pass arrangement, in which the substrate web 60 moves in only one direction along the substrate path (e.g. forward) and moves past each deposition region only once.

In this example the deposition regions 45A and 45B are also spaced apart from each other and are registered above their respective applicators 43A and 43B. In other examples the deposition regions may at least partially overlap each other. The sources of applicators 43 can be any suitable type including, for example, resistance or induction-heated boats, jet sources, magnetron sources, electron beam sputtering sources and similar. These are selected and sized according to known principles, depending on the desired rate of deposition, required coating adhesion, etc.

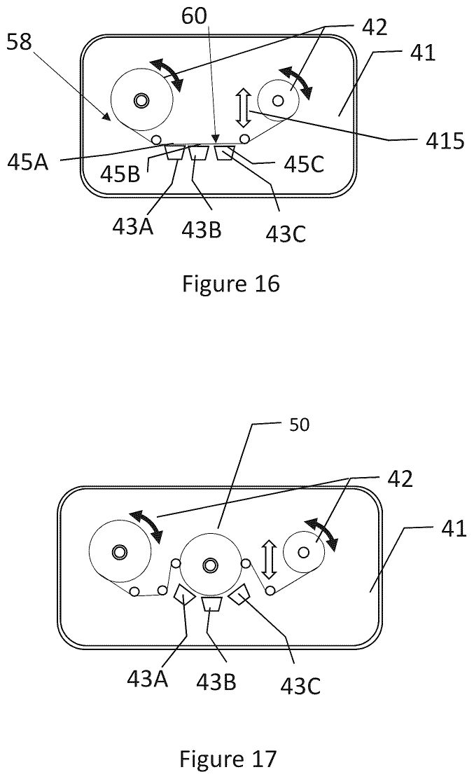

Optionally, referring to FIGS. 16-18, a physical vapour deposition apparatus may be configured to include three or more applicators 43A, 43B and 43C that are associated with three respective deposition regions 45A, 45B and 45C within the chamber 41. Each applicator 43A-C may apply a different material to the substrate material, which may help facilitate the manufacture of a three layer anode assembly, for example including a reactive film, a conductivity film and a performance film, or a reactive film, a protective film and a gas protection or any other suitable combination of the films described herein. This may also facilitate the production of a four layer assembly, for example if the assembly included two different performance films (or other film) that are deposited in successive passes but that can utilize a common applicator. While these embodiments show three applicators 43A-C, other examples may incorporate 4, 5, 6 or more applicators.

Optionally, the apparatus may include a cooling apparatus that can be used to help reduce and/or control the temperature of the collector foil substrate while undergoing deposition. This may help keep the foil substrate at a desired operating temperature—for example, below about 100° C. for aluminum foils. This may help reduce the likelihood of the foil substrates or coatings being damaged during the deposition process. As each deposition operation is conducted and utilizes materials at elevated temperatures, in some arrangements, increasing the number of deposition operations that are performed may cause a greater temperature increase in the foil substrate. To help control the temperature of the substrate the cooling apparatus may be configured to include one cooling member, such as the cooling roller 50 in FIG. 17 that can be brought into contact with the moving substrate. The multiple deposition applicators 43A-43C can be arranged so that the associated deposition zones on the substrate are in communication with the common cooling roller 50.

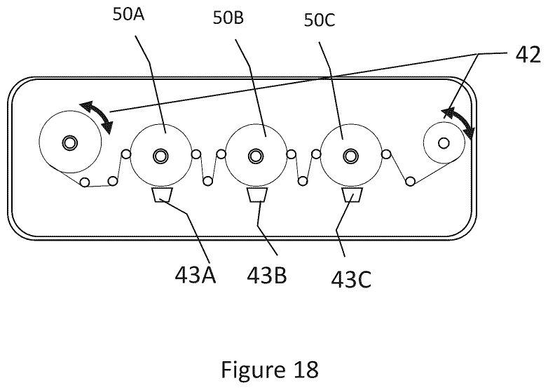

Alternatively, instead of using a common roller 50 to cool two or more deposition zones, the cooling apparatus may include multiple cooling devices, such as multiple rollers 50A, 50B and 50C as shown in FIG. 18, each of which is aligned with a respective applicator 43A-C and configured to cool a respective deposition region.

It may be possible, and may be preferred in some examples to sequentially apply the desired coatings and materials, including reactive and unreactive metal coatings during the same rolling operation (i.e. in a single pass of the web along the deposition path), provided that the total mass flux of each metal is sufficient to deposit the desired thickness of each respective metal in one pass of the substrate web. This may help simplify operation of the deposition apparatus and may help reduce manufacturing time and complexity in some circumstances. For example, this may reduce the need to use reversible spindles.

For example, the method for manufacturing the multi-layer anode assembly be a single-pass method in which a substrate web, including at least a current collector web and optionally a protective film as described herein, is conveyed in a processing direction along a deposition path includes multiple deposition regions (with respective deposition applicators or other apparatuses) that are arranged in sequence. As the substrate web passes through the sequential deposition regions different materials can be applied and a variety of films can be formed and layered on each other. Preferably, the apparatus can be configured so that the substrate web only needs to pass along the deposition path once-from an inlet (where the incoming substrate web is received, preferably from a feed roll).

This method can include the step of unwinding a continuous substrate web from a suitable substrate feed roll, and conveying the substrate web in a first/forward process direction along a deposition path that is provided within a suitable processing chamber of a single-pass physical vapor deposition apparatus. The incoming substrate web will preferably include the desired current collector foil that can be unwound from a foil supply or feed roll, or other suitable source.

The process can then include conveying the substrate web in the process direction through one or more deposition zones that are located along the deposition path. The number and configuration of each deposition zone may vary between different apparatuses or process operations, and may be based on, for example, the number and types of different films that are intended to be deposited on a given assembly. This may include one or more, optional substrate deposition zones that can apply material, such as a protective film, to the current collector foil, as well as optional lithium deposition zone(s), interface deposition zone(s) and cover deposition zone(s). In some arrangements the apparatus may include a unique deposition zone for each layer/film that is applied to the assembly, while in other arrangements a given deposition zone may include two or more suitable applicators or may be otherwise configured to allow two or more layers/films to be deposited within a common deposition zone. It is also possible, in some examples, that an apparatus may not include all of the possible types of deposition zones, or for one or more of the applicators and zones to be deactivated during a given production cycle if the respective films are not needed in a given assembly production. For example, in some examples the apparatus need not include a lithium deposition zone within the processing chamber (or it may be present and deactivate) if the lithium is to be added to the assembly in situ. In other examples an interface deposition zone may not be present (or may be deactivated) if a given assembly does not include any interface film layers.

Continuing the example referenced above, the incoming substrate web may be conveyed through a lithium deposition zone along the deposition path and the apparatus may deposit at least a first lithium film onto the assembly outboard of the support surface using a suitable lithium physical vapour deposition applicator. In examples where the current protector is lithium compatible and there are no interface films, the lithium may be deposited directly onto the current collector foil. In other examples, the lithium may be deposited onto the protective film (if present) or onto the exposed surface of the outermost interface film (if any) that is present. Each of these arrangements is understood to be outboard of the support surface of the substrate web.

In addition to the deposition of the lithium material, the manufacturing process may also include at least one additional deposition step, or may include two, three, four or more additional depositions steps that are to be conducted in a prescribed sequence or order of operations, using suitable deposition zones along the deposition path. For example, the process may include conveying the substrate web in the process direction through an interface deposition zone that is along the deposition path and upstream from the lithium deposition zone. The process can then include depositing a first interface film formed from an interface material onto the support surface of the using an interface physical vapour deposition applicator. If both an interface and lithium film are to be provided, the interface film(s) will be deposited first so that interface film(s) can be in their desired location e.g. between the support surface and the first lithium film, so that they can serve their intended function.

The process may also include, optionally, conveying the substrate web in the process direction through a cover deposition zone that is along the deposition path and downstream from both the interface deposition zone (if present) and the lithium deposition zone (if present). In the cover deposition region one or more cover films can be formed from a cover material that allows a lithium ion flux between an electrolyte and the first lithium film and is preferably outboard of any of the previously deposited interface or lithium films. Positioning the cover deposition region(s) downstream from the other deposition regions (if present) can help position the film(s) in the cover region in their desired, generally outboard position such that they can cover the underling lithium films and interface films.

Having passed the desired deposition regions in a single pass, the substrate that will include the desired films and can be a finished, or at least substantially finished a multi-layer anode assembly which can then reach the end/exit of the deposition path and can be stored for further processing or use, such as by winding the multi-layer anode assembly about an output roll that is provided at the outlet of the deposition path.

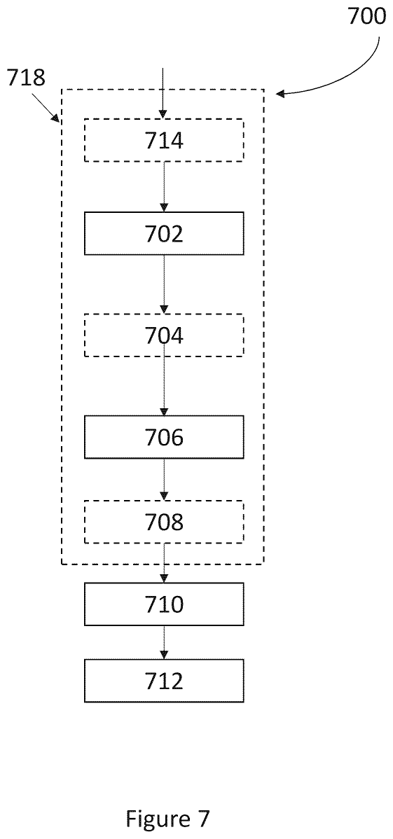

Referring to FIG. 7, one example of a method 700 of manufacturing an anode assembly includes, at step 702 providing a metallic, current collector substrate (e.g. collector 102) within the interior of a metalizing or processing chamber that can be configured at atmospheric pressure and can selectively be configured (such as by using a suitable vacuum pump apparatus or the like) to have an interior operating pressure that is less than atmospheric pressure. The operating pressure in the metallizing chamber can be any suitable pressure that facilitates the desired physical vapour deposition process, and can be between about 10⁻² and 10⁻⁶ Torr in some examples. Preferably, this can help provide an interior the processing chamber that is substantially free of oxygen while the films 104 and 106 are formed.

At optional step 704, the substrate is conveyed to an interface deposition region (if required for a given design) and an interface film can be deposited using a suitable applicator.

At step 706 the web is conveyed to a lithium deposition region and a lithium film is deposited. The web can then continue and optionally, may pass through one or more cover deposition regions, at optional step 708, and may then exit the deposition path at step 710 and be wound on an output roll. Optionally, a protective layer may be applied to the current collector foil, at step 714 if such a layer is desired based on the properties of the particular films being used. This may be done prior to the interface deposition step 704, and if a protective layer is to be included it will be deposited before the lithium film is deposited in step 706 in this example. In this arrangement, steps 714-708 as illustrated can be conducted in a single pass along a deposition path, and preferably within a common deposition processing chamber (shown schematically at 716) and during a single vacuum cycle of the processing chamber 716.

The roll can then be stored and/or sent for further processing, such as using the created anode assemblies in batteries, etc. at step 712. Preferably, the collector 102 material is a continuous, metallic foil that is unwound from a first input or feed roll prior to step 602, via optional step 608, and then wound onto a first output roll after step 606, via optional step 610. In this arrangement, steps 604 and 606 can preferably be carried out while the continuous, metallic foil web is moving between the first feed roll and the first output roll along the deposition path.

Alternatively, in some examples described herein, the lithium material may not be included in the assembly as it exits the deposition path, and may be added in a subsequent step. In those situations, the deposition apparatus may omit the lithium deposition zone or it may be rendered inactive. As the substrate moves along the deposition path it may be covered with one or more suitable films, such as protective films, interface films and cover films, that are applied by suitable, sequentially arrange applicators. In these circumstances, the multi-layer substrate that emerges from the end of the deposition path can be referred to as an anode assembly (without the lithium) or as an intermediary web that includes substantially all of the components of the anode assembly but is waiting for the lithium to be added. The intermediary web can be wound on an output roll for temporary storage or may be handled and processed using any suitable techniques. To add the lithium material, portions of the intermediary web (or optionally the entire web) can be placed in a suitable electrochemical cell that includes a positive electrode and a lithium source (as shown and described with reference to Figurers 19-23). The electrochemical cell may be within a battery or other such end product, or may be a separate apparatus that is used to plate lithium onto the intermediary web to provide lithiated anode assemblies, which can then be removed from the plating cell and inserted into other batteries or devices.

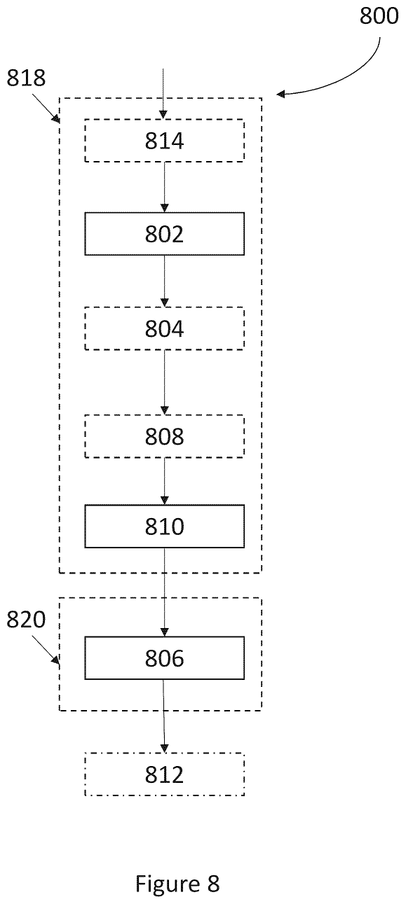

For example, referring to FIG. 8, another example of a method 800 of manufacturing an anode assembly includes, at step 802 providing a metallic, current collector substrate within the interior of a metalizing or processing chamber 818 that can be configured at atmospheric pressure and can selectively be configured (such as by using a suitable vacuum pump apparatus or the like) to have an interior operating pressure that is less than atmospheric pressure. At optional step 704, the substrate is conveyed to an interface deposition region (if required for a given design) and an interface film can be deposited using a suitable applicator.

In this example the lithium film is applied outside of the processing chamber 818, and the lithium application step is bypassed within the processing chamber 818 such that the substrate can be conveyed from the one or more interface deposition steps 804 to one or more optional cover deposition steps at step 808. That is, the web can then continue and optionally, may pass through one or more cover deposition regions, at optional step 808, and may then exit the deposition path at step 810 as an intermediary web assembly to be wound on an output or transfer roll. Optionally, a protective layer may be applied to the current collector foil, at step 814 if such a layer is desired based on the properties of the particular films being used. This may be done prior to the interface deposition step 804, and if a protective layer is to be included it will be deposited before the substrate leaves the deposition chamber 818 in this example.

The intermediary web assembly, or portions thereof, can then be positioned in a suitable electrochemical cell 820 when the lithium film can be created by plating lithium into the lithium hosting region of the intermediary web assembly in the lithium application step 806. The lithiated assembly can then remain within the electrochemical cell 820 (for example if the cell 820 is a finished battery) or may be removed and further processed or utilized at optional step 812.

At step 706 the web is conveyed to a lithium deposition region and a lithium film is deposited. In this arrangement, steps 714-708 as illustrated can be conducted in a single pass along a deposition path, and preferably within a common deposition processing chamber (shown schematically at 716) and during a single vacuum cycle of the processing chamber 716.

The roll can then be stored and/or sent for further processing, such as using the created anode assemblies in batteries, etc. at step 712. Preferably, the collector 102 material is a continuous, metallic foil that is unwound from a first input or feed roll prior to step 602, via optional step 608, and then wound onto a first output roll after step 606, via optional step 610. In this arrangement, steps 604 and 606 can preferably be carried out while the continuous, metallic foil web is moving between the first feed roll and the first output roll along the deposition path.

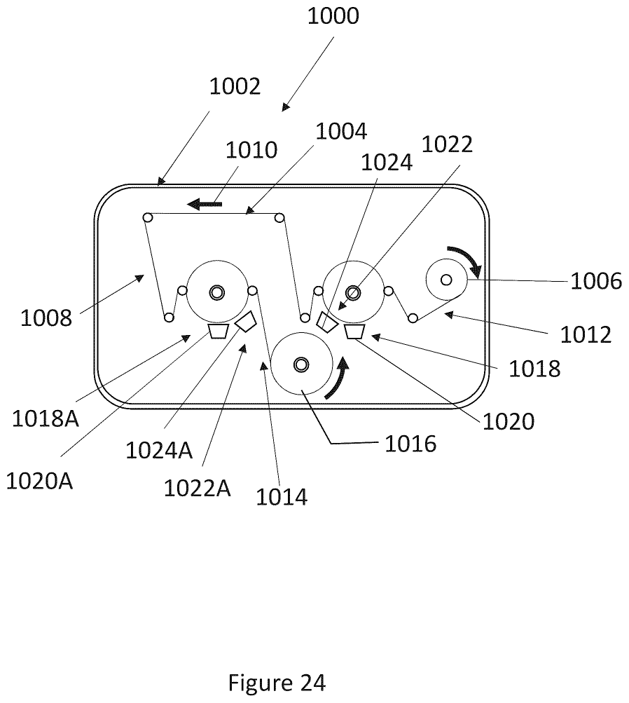

Referring to FIG. 24, one example of a single-pass deposition apparatus 1000 is schematically illustrated. Preferably, as described herein the apparatus 1000, and others described herein, are configured to include a first set of physical vapour deposition applicators (such as applicators 1020 and 1024) that are positioned to deposit material (or provide gas for reactions, etc.) on a first side of the substrate web, and a second set of physical vapour deposition applicators (such as applicators 1020A and 1024A) that are positioned to of deposit material (or provide gas for reactions, etc.) on a second side of the substrate web. Optionally, as illustrated the second set of applicators can be downstream from the first set of applicators such that the first side of the substrate web is coated before the second side. Alternatively, the some of the second set of applicators may be intermixed with some of the first set of applicators, so that some portions of the first and second sides are alternatingly treated along the deposition path. For example, both lithium films may be deposited before either cover layer film is provided, or the like. Having two sets of applicators, regardless of their arrangement, can allow a generally bare substrate web to enter the processing chamber and for a substantially complete, two-side, multi-layer anode assembly to be extracted at the end of the deposition path. This may be an advantage over conventional techniques in which the webs require at least two or more passes through suitable apparatuses in order to adequately coat either the first or the first and second sides of the substrate web.

While only portions of the apparatus 100 are schematically illustrated for clarity, the 1000 may include any suitable features, mechanism, feed systems, controllers and other features of the deposition apparatus 400 described herein, and the description below of apparatus 1000 will be focused on the single-pass processing chamber 1002 (which could be used in place of chamber 41 where suitable).

The apparatus 1000 is configured to receive an incoming substrate web 1004 (which can be analogous to the webs 60 described herein) which is fed from a substrate supply or feed roll 1006 and travels along deposition path 1108 within the chamber 1102 in a process direction 1010 from a path inlet 1012 to a path outlet 1014. A product or output roll 1016 is located at the outlet 1014 to receive and take up the multi-layer anode assembly web that exits the deposition path 1008.

In this example, the apparatus 1000 is configured to, in a single-pass, produce an assembly with a current collector substrate, a film in the lithium hosting region and a film in the cover region, and includes suitable deposition zones and applicators arranged in sequence along the deposition path 1008. Specifically, in this example, the apparatus 1000 is configured to utilize a lithium compatible metal foil current collector as the substrate web, so a protective layer deposition zone is not required. Instead, the web 1004 can advance to a lithium deposition zone 1018 (like zones 45A-C) with an applicator 1020 (like applicators 43A-C) that includes a lithium thermal source. The lithium material can be deposited directly on the web 1004 to provide the lithium film.

Downstream from the lithium deposition zone 1018, the apparatus 1000 includes a cover deposition zone 1022 containing a cover applicator 1024 that is configured to form a cover film. In this example, the cover applicator 1024 includes a gas supply nozzle/apparatus that can be used to provide a gas treatment on the exposed surface of the lithium film that was deposited in zone 1018. For example, the applicator 1024 can be connected to a suitable gas source and provide a substantially pure, such as at least 99%, and preferably 99.9%, or 99.99% or 99.999%, or 99.999% pure cover gas that can react with exposed face of the lithium film and can form, in situ, a reacted cover layer. Suitable gases can include nitrogen and carbon dioxide, which may react with the exposed lithium to form a film/skin of lithium nitride or lithium carbonate respectively, which can help protect the underlying lithium film and may help inhibit oxidation, etc. If these layers are the only desired layers for the assembly, any apparatus or deposition zones downstream from the cover deposition zone 1022 can be deactivated and the web 1004 can travel to the output roll 1016 without any further processing on the front side of the web. If the resulting anode assembly is intended to be double sided, a matching pair of back/second side deposition zones, identified using like reference characters with an “A” suffix, can be provided downstream from the front/first side deposition zones described above. In this arrangement, both sides of the substrate web can be coated as desired in a single-pass along the deposition path 1004. If two sided coating is not required, the second deposition zones and applicators 1018A, 1020A, 1022A and 1024A need not be provided and the deposition path 1104 could end closer to cover deposition zone 1022.

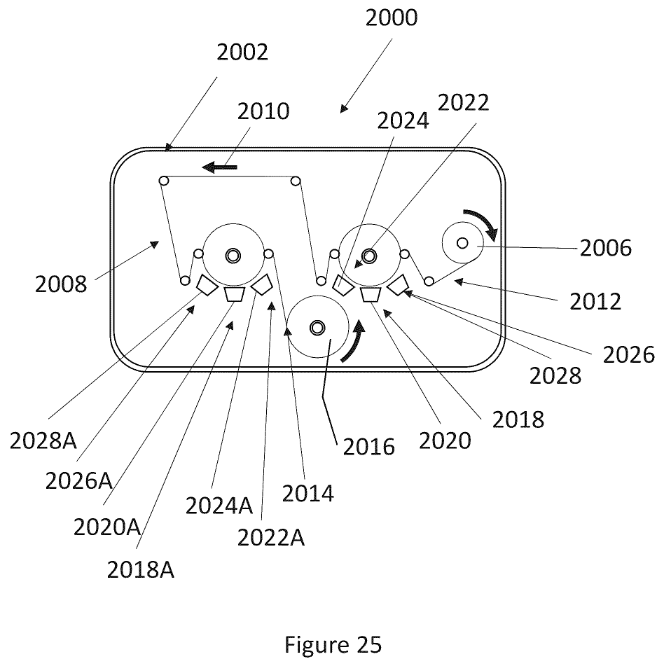

Referring to FIG. 25, another schematic example of a single-pass deposition apparatus 2000 is illustrated. The apparatus 2000 is analogous to apparatus 1000 and like features are illustrated using like reference characters indexed by 1000. In this example, the apparatus 2000 is configured to, in a single-pass, produce an assembly with a current collector substrate, a film in the interface region, a film in the lithium hosting region and a film in the cover region, and includes suitable deposition zones and applicators arranged in sequence along the deposition path 2008.

Specifically, in this example, the apparatus 2000 is configured to utilize a lithium compatible metal foil current collector as the substrate web, so a protective layer deposition zone is not required. Instead, the web 2004 can advance to a lithium deposition zone 2018 (like zones 45A-C) with an applicator 2020 (like applicators 43A-C) that includes a lithium thermal source.

However, unlike apparatus 1000, the apparatus 2000 also includes an interface deposition zone 2026, including a deposition applicator 2028, that is positioned upstream from the lithium deposition zone 2018 and is operable to deposit an interface material, such as depositing a film of copper via a thermal evaporation source or depositing a layer of nickel from a magnetron sputtering source (or the like), onto the substrate web before it reaches the lithium deposition zone 2018. In this arrangement, the lithium layer deposited in the lithium deposition zone 2108 is deposited onto the interface copper film, rather than directly on the web 2004.

Downstream from the lithium deposition zone 2018, the apparatus 2000 includes a cover deposition zone 2022 containing a cover applicator 2024 that is configured to form a cover film. In this example, the cover applicator 2024 includes a gas supply nozzle/apparatus that can be used to provide a gas treatment on the exposed surface of the lithium film that was deposited in zone 2018. In other examples the applicator 2024 may deposit a metallic cover film, including any of the cover materials described herein.

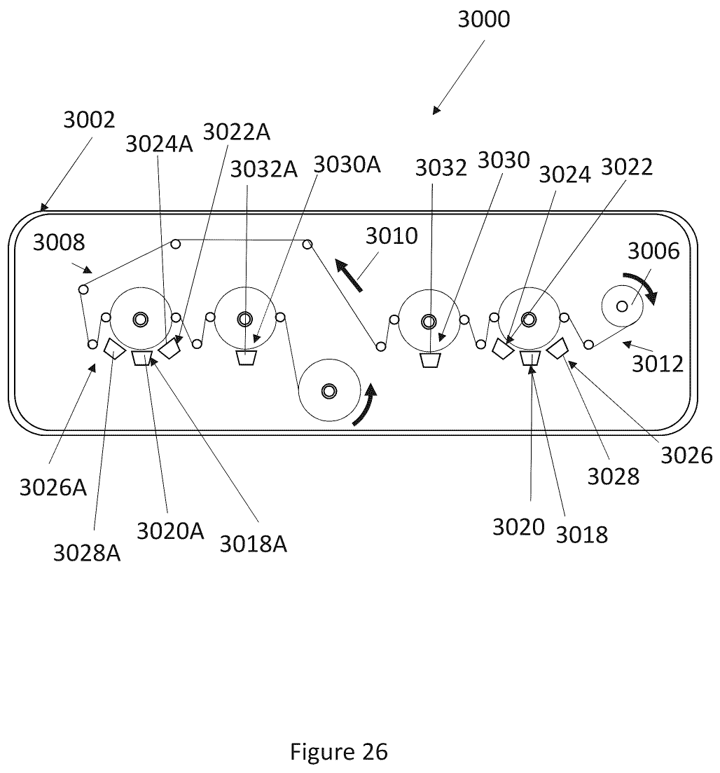

Referring to FIG. 26, another schematic example of a single-pass deposition apparatus 3000 is illustrated. The apparatus 3000 is analogous to apparatus 1000 and like features are illustrated using like reference characters indexed by 1000. In this example, the apparatus 3000 is configured to, in a single-pass, produce an assembly with a current collector substrate, a film in the interface region, a film in the lithium hosting region and two films in the cover region, and includes suitable deposition zones and applicators arranged in sequence along the deposition path 2008.

Specifically, in this example, the apparatus 3000 is configured to utilize an aluminum metal foil current collector, so the first deposition zone that is provided along the deposition path 3008 can be used to apply a protective film on the aluminum foil. This first deposition zone may be referred to as a protective deposition zone or the protective film material such as a layer of nickel can include a protective deposition zone 3030 protective layer deposition zone is not required. As shown in FIG. 26, the apparatus 3000 includes a deposition zone 3026, including a deposition applicator 3028, that is positioned upstream from the lithium deposition zone 3018 and is operable to deposit a material that can function as either an interface film, a protective film or both, such as depositing a layer of nickel from a magnetron sputtering source.

Downstream from the deposition zone 3026, including a deposition applicator 3028, is the lithium deposition zone 3018 and applicator 3020 that is operable to deposit an lithium film onto the nickel film.

Downstream from the lithium deposition zone 3018, the apparatus 3000 includes a first cover deposition zone 3022 containing a cover applicator 3024 that is configured to form a first cover film, such as a layer of tin deposited from a second magnetron sputtering source. In addition to the first cover deposition zone 3022, a second cover deposition zone 3030 is included on the deposition path and includes a second applicator 3032 to apply a second cover film over the layer of tin (for example, or any other intervening layer) which can help impart different properties to the assembly. IN this example, a 750 nm thick layer of polyethylene oxide (PEO) can be from a second thermal evaporation source (e.g. the applicator 3032) to provide the outermost skin/film on the assembly. This sequence of steps can be repeated on the second side of the substrate using the second set of deposition zones and applicators denied with the “A” suffix.

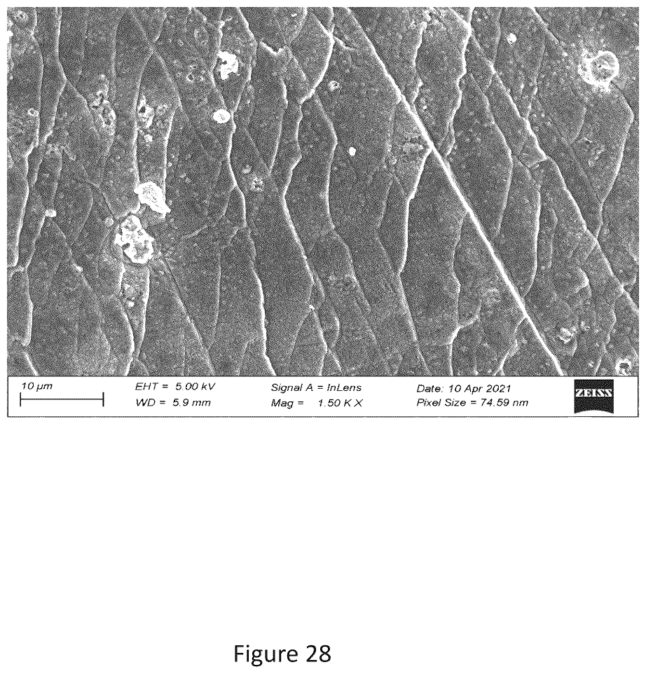

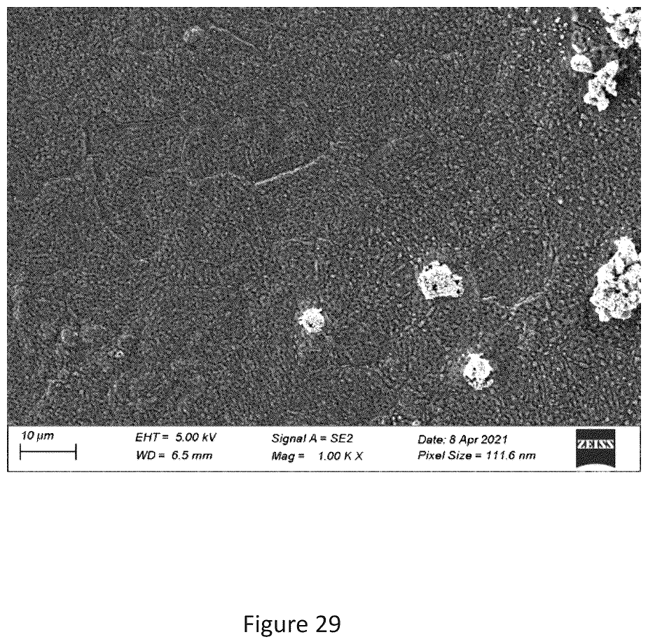

As described herein, prior attempts to provide lithium anodes suitable for liquid electrolyte metal lithium ion (LMB), hybrid lithium metal (HLB) and solid-state batteries (SSB) have not provided all of the advantages described herein and, as described above have typically been made by foil rolling and extrusion processes. The difficulties in rolling lithium, which is reactive, physically weak, and suffers from self-adhesion, are well known and limit the practical thickness at which such foils can be rolled and handled to greater than 20 microns. These difficulties results in excessive material use, high unit costs and impact negatively on the economic viability of the anodes. Moreover, the lubricants introduced during the rolling process, inclusions from ingot casting, and the rolling mill atmosphere all contribute to physical and chemical defects in the surface of the rolled foil, as shown in the SEM micrographs of FIGS. 28 and 29. FIG. 28 shows a sample of an anode formed using the conventional foil materials and assembly techniques after symmetric cycling for 50 cycles using a sulphide electrolyte and a variety of ridges and other surface imperfections are visible in the micrograph (note, the white particles in the image are electrolyte residue). In contrast, FIG. 29 shows an example of an assembly that utilizes a PVD deposited lithium film in accordance with the present teachings (rather than a foil) after symmetric cycling for 50 cycles using sulphide electrolyte and the surface appears to be relatively smoother (again, white particles are electrolyte residue). The surface defects in the conventional assembly (FIG. 28) can have negative consequences for the performance of the foil as a battery anode, by creating non-uniformities in the plating and stripping characteristics of the anode, increasing impedance, interfering with contact between the anode and electrolyte, and introducing chemical impurities that may react with other components of the cell.

Based on the teachings herein, the inventors created and reviewed several examples of anode assemblies having different features and combinations of the various layers and regions described herein. Some of these exemplary examples are described below.

Example 1: One example of an anode assembly includes a current collector substrate, a lithium hosting region and a cover region. The current collector substrate is an electro-deposited copper foil 150 mm wide, and 6 microns thick (or between about 4 and about 10 microns). To this was applied a 5 micron (or between about 1 and 10 microns) thick layer of lithium metal via thermal evaporation type of physical vapour deposition at a rate of approximately 15 micron-m/min on both sides of the substrate. Without breaking vacuum, and beyond the deposition zone, a gas treatment of substantially pure, and preferably up to 99.9999% pure nitrogen was applied to form a lithium nitride layer in the cover region of the anode. Lithium nitride has high ionic conductivity around 10⁻³ S/cm and forms a stable solid electrolyte interphase with some electrolytes, improving the durability of the anode of the example.

Example 2: Another example of an anode assembly includes a current collector substrate, a lithium hosting region and a cover region. The current collector substrate is an electro-deposited copper foil 150 mm wide, and 6 microns thick (optionally between about 4 microns and about 10 microns). To this was applied a 5 micron (or between about 1 and 10 microns) thick layer of lithium metal via thermal evaporation at a rate of approximately 15 micron-m/min on both sides of the substrate. Simulating a continuous process the material was moved to an argon glovebox and 100 nm and 200 nm of zinc (Zn) was applied to the cover regions of two samples, forming an alloy in situ on the surface of the samples. LiZn alloy has the beneficial property of improving charge transfer at the anode surface, resulting in more uniform plating of and stripping of the lithium metal.

Example 3: Another example of an anode assembly includes a current collector substrate, an interface region, a lithium hosting region and a cover region. The current collector substrate can be a rolled stainless steel foil 5 microns thick (or between about 1 and 10 microns). To this can be applied a 1 micron thick layer (optionally between about 0.5 microns and about 2 microns) of copper via a thermal evaporation source in the interface region, followed by lithium metal via thermal evaporation in the lithium hosting region, on both sides of the substrate. Without breaking vacuum, and beyond the deposition zone, a gas treatment of substantially pure, and preferably up to 99.9999% pure, carbon dioxide can applied to form a lithium carbonate (Li₂CO₃) gas protection layer in the cover region of the anode.

Stainless steel is a relatively cheaper substrate because it includes predominantly low cost materials like iron and chrome. It is not an ideal current collector material because of its low electrical conductivity, which is some 40 times lower than that of copper. By introducing a thin layer of copper in the interface region, this shortcoming is overcome, rendering an effective anode material using an abundant low-cost substrate material. Additionally, the inclusion of a lithium carbonate layer in the cover region passivates the surface of the lithium, making it more durable against contact with the atmosphere, allowing longer handling and storage in the dry-room environment without degradation of the anode surface.

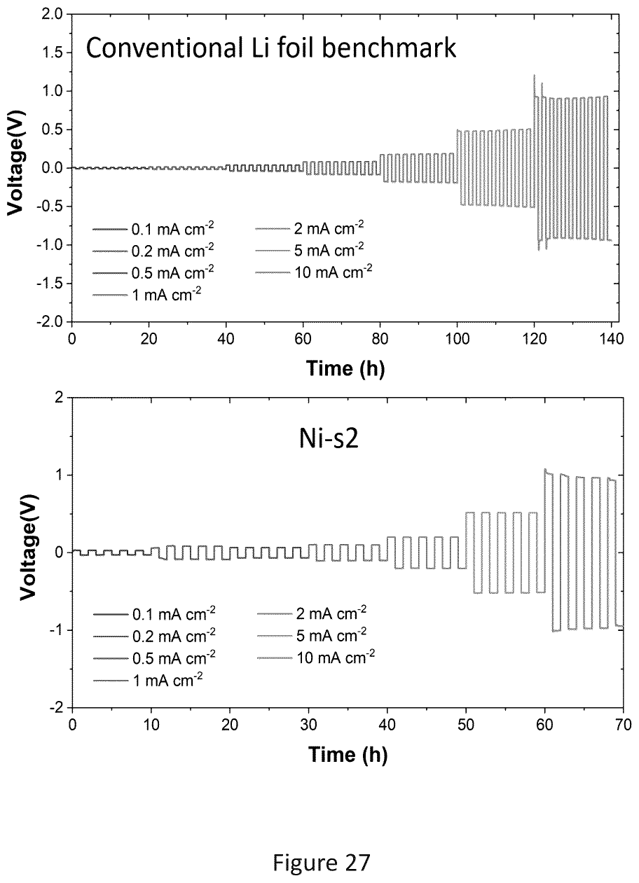

Example 4: Referring another example of an anode assembly includes a current collector substrate, an interface region, a lithium hosting region and a cover region. The current collector substrate can be a rolled aluminum foil 150 mm wide and 12 microns (or between 5 and 15 microns) thick. To this can be applied a 300 nm (or between 100 and 500 nm, and preferably 200 nm to 400 nm) thick layer of nickel from a magnetron sputtering source in the interface region, followed by lithium metal via thermal evaporation in the lithium hosting region, without breaking vacuum, and beyond the deposition zone, a gas treatment of substantially pure, and preferably up to 99.9999% pure, carbon dioxide can applied to form a lithium carbonate layer in the cover region of the anode, with the sequence being repeated on both sides of the substrate. FIG. 27 is a plot showing cycling data for conventional foil and for material according to this example 4 showing materially similar performance between the conventional lithium foil-based assembly and the assembly formed in accordance with the present teachings. This helps demonstrate that assemblies having at least some of the processing and cost advantages as described herein can offer acceptable performance that is comparable to conventional designs.

The anode assembly of Example 4 offers several advantages. Firstly, the substrate material being aluminum has much lower density than copper, consequently a substrate of the specified thickness in aluminum has approximately the same areal mass as a copper current collector of 4 microns thickness, and so offers specific energy benefits over a similar anode assembly made with the latter material. Secondly, because aluminum is typically one third to one quarter of the cost on a mass basis, the material cost of the current collector is dramatically reduced. This is enabled by the use of the nickel layer as a protective material layer in the interface region (or in the substrate region) to reduce or eliminate lithium ion transfer from the lithium hosting region to the aluminum current collector where it could alloy with the substrate and degrade it mechanically. The lithium carbonate passivation or gas protection layer performs a similar function to that described in Example 3.

FIG. 27 shows comparative critical current testing of material made according to Example 4 and conventional rolled foil. Under similar conditions, the anode has nearly identical cycling behavior, while representing a significantly less costly battery cell component that can be made in much larger formats and with less overall material use than is possible with conventional rolled foils.

Example 5: Referring yet another example of an anode assembly includes a current collector substrate with a protective film applied, a lithium hosting region and a cover region. The current collector substrate can be a rolled aluminum foil 600 mm wide and 12 microns thick. To this can be applied a 300 nm thick layer of nickel from a first magnetron sputtering source in the interface region, followed by lithium metal via thermal evaporation from a first thermal evaporation source in the lithium hosting region, followed by a 200 nm thick layer of tin from a second magnetron sputtering source in the cover region, and a 750 nm thick layer of polyethylene oxide (PEO) from a second thermal evaporation source in the outer portion of the cover region, with the sequence being repeated on both sides of the substrate.

The anode assembly of Example 5 offers the same advantages as Example 4, but has the additional two additional advantages. The PEO deposited in the cover region is a solid electrolyte that can readily interface with a cathode material, a solid electrolyte separator, or potentially some liquid electrolytes in a hybrid cell. PEO is a known solid electrolyte that has some disadvantages, namely low ionic conductivity at room temperature. Application with the method of this invention allows an ultra-thin PEO film not practically achievable with conventional assembly methods to be formed. This greatly mitigates the low room-temperature ionic conductivity of the material, and facilitates its use in a variety of battery cells. Advantageously, deposition of PEO allows for excellent wetting between this and underlying layers, improving the uniformity of ion transfer and further reducing the propensity to form dendrites. Secondly, a transfer layer or transfer film, such as a layer of tin (or, for example, zinc (Zn), magnesium (Mg), carbon (C), indium (In), silver (Ag), bismuth (Bi), lead (Pb)) in the covering region partially alloys with the lithium, producing a Li—Sn alloy with good charge transfer properties. This promotes rapid re-organization of the interface during plating and stripping, and hence suppressing dendrite and other defect formation.

Table 8 summarizes some of the properties of examples described herein, and provides comparative areal density, thickness and indicative raw material costs to illustrate some of the benefits of the invention. In each of these examples, even discounting some of the performance benefits imparted by the functional layers, the anode assemblies according to the present teachings offer significantly lower areal density (higher battery cell specific energy), reduced thickness (increased battery cell energy density) and lower input material costs (reduced cost per kilowatt hour of energy storage), thereby conferring large performance advantages to the cells using such anode assemblies.

TABLE 8

| | Materials and Thickness | | | | | | Performance Indicators | | |
|---|---|---|---|---|---|---|---|---|---|
| | | | Interface | | Lithium Hosting | | Area | Total | Indicative Raw [symbol] |
| | Substrate | | Region | | Region | Cover Region | Density (g/m²) | Thickness (μm) | @ 2021 October LM [symbol] |
| [symbol] e 1 | Copper 6 | μm | none | | Lithium 5 μm | Lithium nitride | 59 | 16.0 | 1.32 |
| [symbol] e 2 | Copper 6 | μm | none | | Lithium 5 μm | Zinc 0.1 & 0.2 μm | 62 | 16.4 | 1.33 |
| [symbol] e 3 | Stainless Steel 5 | μm | Copper 1 | μm | Lithium 5 μm | Lithium carbonate | 61 | 17.0 | 1.09 |
| [symbol] e 4 | Aluminum 12 | μm | Nickel 0.3 | μm | Lithium 5 μm | Lithium carbonate | 43 | 22.6 | 1.00 |
| [symbol] e 5 | Aluminum 12 | μm | Nickel 0.3 | μm | Lithium 5 μm | Tin 0.2 μm | 48 | 24.5 | 1.12 |
| | | | | | | PEO 0.75 μm | | | |

| | | | | | | | | |
|---|---|---|---|---|---|---|---|---|
| [symbol] ne | Copper 6 | μm | None | Lithium 30 μm | None | 86 | 66.0 | 5.33 |

[symbol]

indicates data missing or illegible when filed

When built in accordance with the teachings herein, the anode assemblies may have total or assembly thickness (measured from the rear side of the substrate region to the outer face of the cover region in a single sided anode) that is preferably less than about 60 μm or about 50 μm, and may between about 10 μm and about 50 μm, between about 15 μm and about 30 μm, between about 16 and about 25 μm or other suitable ranges.

When built in accordance with the teachings herein, the anode assemblies may have areal densities of less than about 80 g/m², or less than about 70 g/m² or less than about 60 g/m², and optionally may be between about 30 g/m² and 70 g/m², or between about 40 g/m² and 65 g/m².

While the teachings herein have been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

As used herein, the term “about” is understood to mean that features of a given assembly may vary from the stated value or ranges by a relatively small, such as by 10% or 15% of the stated value, provided that such variation does not have a material effect on the function or capabilities of the assembly. For example, an assembly that has an areal densities that less than about 70 g/m² would be understood by the skilled person to include assemblies with areal densities of 70.1 g/m² or possible 71-74 or 75 g/m² if such assemblies functioned in a materially similar way to the described example when in use, but would likely not be understood by a person skilled in the art to include assemblies with an areal density of more than 80 g/m² . . . . This minor variation to the stated ranges can account for manufacturing tolerances, measurement errors or challenges and to refer to embodiments of the described assemblies that do not vary materially from those described and that could be used as an alternative to the examples described herein.

All publications, patents and patent applications referred to herein are incorporated by reference in their entirety to the same extent as if each individual publication, patent, or patent application was specifically and individually indicated to be incorporated by reference in its entirety.

1.-23. (canceled)

24. A multi-layer, lithium anode assembly for use in a lithium-based battery, the anode assembly comprising:
a) a substrate region having a lithium compatible support surface, and comprising a non-lithium current collector;
b) a lithium hosting region overlying the support surface and configured to retain a least at first lithium material film;
c) at least one of:
i. an interface region located between the lithium hosting region and the support surface and comprising at least one interface film positioned between the support surface and the lithium hosting region to physically separate the substrate region and the lithium hosting region, the at least one interface film being formed by a physical deposition of a lithium compatible material onto the support surface and being electronically conductive to allow an electron flux between the lithium hosting region and the support surface; and
ii. a cover region located outboard of the lithium hosting region including at least one cover film covering an outboard side of the lithium hosting region, the cover region allowing a lithium ion flux between an electrolyte and the lithium hosting region.

25. The anode assembly of claim 24, wherein the interface region is operable to do at least one of inhibiting dendrite formation when lithium is deposited in the lithium hosting region when in use, and improving lithium ion flux or ion distribution between the lithium hosting region and the substrate region when in use.

26. The anode assembly of claim 24, wherein the cover region is operable to do at least one of inhibit irreversible reactions between the lithium hosting region and the electrolyte or surrounding environment, inhibit dendrite formation when lithium is deposited in the lithium hosting region when in use, and improving lithium ion flux or ion distribution between the lithium hosting region and the electrolyte when in use.

27. The anode assembly of claim 24, comprising both the interface region and the cover region.

28. The anode assembly of claim 24, wherein the first lithium material film is formed by a physical deposition of a lithium compatible material into the lithium hosting region.

29. The anode assembly of claim 24 wherein the current collector comprises at least one of copper, aluminium, nickel, stainless steel, steel, an electrically conductive polymer, a polymer.

30. The anode assembly of claim 24, wherein the current collector is configured as a continuous web.

31. The anode assembly of claim 24, wherein the current collector has a collector thickness of between about 1 and about 100 microns, and preferably of between about 4 and about 70 microns or between about 5 and 15 microns.

32. The anode assembly of claim 24, wherein the current collector is formed from a lithium compatible material and has a front surface that comprises the support surface.

33. The anode assembly of claim 32, wherein the lithium compatible material comprises a metal foil including at least one of copper, steel, and stainless steel.

34. The anode assembly of claim 24, wherein the current collector is formed from a non-lithium compatible material and further comprising a first protective film bonded to and covering a front surface of the current collector and providing the support surface, the first protective film being formed from a protective metal that is electronically conductive and resistive to lithium ion flux whereby electrons can travel through the first protective film from the lithium hosting region to the current collector and the lithium hosting region is spaced from and at least substantially ionically isolated from the current collector such that and diffusion of lithium ions from the lithium hosting region to the current collector through the first protective film is substantially prevented.

35. The anode assembly of claim 34, wherein the protective metal comprises at least one of copper (Cu), nickel (Ni), silver (Ag), stainless steel and steel, titanium (Ti), zirconium (Zr), molybdenum (Mo), or alloys thereof.

36.-39. (canceled)

40. The anode assembly of claim 24, wherein the least one interface film comprises at least one of tin (Sn), zinc (Zn), magnesium (Mg), carbon (C), copper (Cu), indium (In), silver (Ag), bismuth (Bi), lead (Pb), cadmium (Cd), antimony (Sb) and selenium (Se).

41. The anode assembly of claim 24, wherein least one interface film has a thickness of between about 1 and about 75,000 Angstroms, and preferably between about 200 and about 7500 Angstroms.

42. The anode assembly of claim 24, wherein the least one interface film comprises at least a first deposition-enhancing film including at least one of tin (Sn), zinc (Zn), magnesium (Mg), carbon (C), indium (In), silver (Ag), bismuth (Bi), lead (Pb) and positioned to contact the lithium hosting region, whereby dendrite formation is inhibited when the first lithium material film is deposited in the lithium hosting region.

43. (canceled)

44. The anode assembly of claim 42, wherein the interface region further comprises at least a first bonding film adjacent the first deposition-enhancing film and including at least one zinc (Zn), cadmium (Cd), magnesium (Mg), antimony (Sb), indium (In), bismuth (Bi), nickel (Ni), lead (Pb) and selenium (Se) and positioned between the support surface and the lithium hosting region thereby providing an improved bond between the support surface and the lithium hosting region than would be achieved between the support surface and the lithium hosting region in the absence of the first bonding film.

45.-46. (canceled)

47. The anode assembly of claim 24, wherein the least one interface film comprises at least a first bonding film including at least one zinc (Zn), cadmium (Cd), magnesium (Mg), antimony (Sb), indium (In), bismuth (Bi), nickel (Ni), lead (Ph) and selenium (Se) and positioned between the support surface and the lithium hosting region thereby providing an improved bond between the support surface and the lithium hosting region than would be achieved between the support surface and the lithium hosting region in the absence of the first bonding film and wherein the interface region further comprises at least a first deposition-enhancing film adjacent the bonding film and including at least one of tin (Sn), zinc (Zn), magnesium (Mg), carbon (C), indium (In), silver (Ag), bismuth (Bi), lead (Pb) and positioned to contact the lithium hosting region, whereby dendrite formation is inhibited when the first lithium material film is deposited in the lithium hosting region.

48.-50. (canceled)

51. The anode assembly of claim 24, wherein the interface region is free of a metal foil and further comprising at least one cover film in the cover region and the first lithium material film comprises lithium metal deposited into the lithium hosting region after the at least one cover film is in place.

52. The anode assembly of claim 24, wherein the lithium hosting region is free of a lithium foil.

53. (canceled)

54. The anode assembly of claim 24, wherein the at least one cover film comprises at least a first passivation film covering an outboard side of the lithium hosting region and inhibiting reactions between the lithium hosting region and the ambient environment, the first passivation film being formed from a passivation material that inhibits gas diffusion and allows lithium ion flux through the first passivation film.

55. The anode assembly of claim 54, wherein the passivation material comprises at least one of a nitride, a hydride, a carbonate, lithium carbonate, lithium nitride, lithium oxide, lithium sulphide, an oxide, lithium aluminate, a sulphide, gold, platinum, polyethylene oxide, lithium catehcols, and a lithium ion conductive polymer.

56.-124. (canceled)
